(19) United States
(12) Patent Application Publication
(10) Pub. No.: US 2019/0356777 A1
(43) Pub. Date: Nov. 21, 2019

(54) REAL-TIME COMMUNICATIONS APPLICATION

(71) Applicants: Reza RAJI, Menlo Park, CA (US); Demetri ARGYROPOULOS, Santa Barbara, CA (US); Ron FERNANDEZ, Santa Barbara, CA (US)

(72) Inventors: Reza RAJI, Menlo Park, CA (US); Demetri ARGYROPOULOS, Santa Barbara, CA (US); Ron FERNANDEZ, Santa Barbara, CA (US)

(21) Appl. No.: 16/364,880

(22) Filed: Mar. 26, 2019

Related U.S. Application Data
(63) Continuation of application No. 15/645,943, filed on Jul. 10, 2017, now abandoned.

(51) Int. Cl. H04M 3/432

(52) U.S. Cl. CPC H04M 3/432; H04M 3/42348

(57) ABSTRACT

Embodiments include a client device configured for telephone communications and including an application or software that configures the client device to, in response to receiving an input to initiate a telephone call to a selected contact, receive data of the selected contact. The client device determines a current time of the selected contact based on a location corresponding to the selected contact, and determine from the data of the selected contact and the current time an appropriate time to call the selected contact. A display generated at the client device includes a message comprising message data representative of the appropriate time to call the selected contact.

### RELATED APPLICATIONS

This application claims the benefit of U.S. Patent Application No. 62/359,924, filed Jul. 8, 2016.

This application claims the benefit of U.S. Patent Application No. 62/470,945, filed March 14, 2017.

This application is a continuation in part of U.S. Patent Application No. 15/010,063, filed Jan. 29, 2016.

### TECHNICAL FIELD

The embodiments described herein relate to applications running on a processor and, more particularly, an application for providing functionality on a smart phone, tablet, or other portable computing device.

### BACKGROUND

Conventional mobile phone technology requires a caller to take a chance on disturbing a called party because of lack of information about the called party's current location or time zone. Consequently a caller may place a call to the called party in San Francisco at 8 PM, with no way of knowing the called party is currently in London where the time is 4 AM.

### BRIEF DESCRIPTION OF THE DRAWINGS

FIG. 1 is a block diagram of the system that includes the alerting application, under an embodiment.

FIG. 2 is a flow diagram of processes of the alerting application, under an embodiment.

FIG. 3 is an example user interface (UI) for controlling Whitespace settings, under an embodiment.

FIG. 4 is an example user interface of a use case involving Whitespace, under an embodiment.

FIG. 5 is an example user interface of another use case involving Whitespace, under an embodiment.

FIG. 6 shows example interactions comprising one or more components of Whitespace, under an embodiment.

FIG. 7 is a table of state conditions and corresponding interactions comprising one or more components of Whitespace, under an embodiment.

FIG. 8 is an operational matrix showing communication scheduling with Whitespace, under an embodiment.

FIG. 9 shows an operational example with sample UI when initiator has the telephone number of the party to be contacted, under an embodiment.

FIG. 10 shows an operational example with sample UI when initiator has the street address of the party to be contacted, under an embodiment.

FIG. 11 shows an operational example with sample UI when initiator has the actual current time zone or location of the party to be contacted, under an embodiment.

FIG. 12 shows integration of Whitespace functionality into speed dial previews, under an embodiment.

FIG. 13 shows contact page for “Larry” including the Whitespace “target” icon, under an embodiment.

FIG. 14 is an example UI contact options page for “Larry” including the Whitespace “target” icon, under an embodiment.

FIG. 15 is an example email template page triggered by the Whitespace application, under an embodiment.

FIG. 16 is an example calendar scheduling interface triggered by the Whitespace application, under an embodiment.

FIG. 17 is an example options interface triggered by the Whitespace application for selecting meeting details, under an embodiment.

FIG. 18 is an example calendar invitation interface triggered by the Whitespace application, under an embodiment.

FIGS. 19-42 include example flows of Whitespace operations, under an embodiment.

### INCORPORATION BY REFERENCE

Each patent, patent application, and/or publication mentioned in this specification is herein incorporated by reference in its entirety to the same extent as if each individual patent, patent application, and/or publication was specifically and individually indicated to be incorporated by reference.

### DETAILED DESCRIPTION

Embodiments include a client device configured for telephone communications and including an application or software that configures the client device to, in response to receiving an input to initiate a telephone call to a selected contact, receive data of the selected contact. The client device determines a current time of the selected contact based on a location corresponding to the selected contact, and determine from the data of the selected contact and the current time an appropriate time to call the selected contact. A display generated at the client device includes a message comprising message data representative of the appropriate time to call the selected contact.

Embodiments described herein include an application or component running on a processor of an electronic device, for example a smart phone, tablet computer, or other personal computing device, that simplify and automate determination of the actual local time for an address book contact with which a communication session is to be initiated. The communication session includes but is not limited to a Web call, Voice-over Internet Protocol (IP) (VoIP) call, and sessions using a messaging application or other communication protocols, to name a few. As used herein, the term “initiator” or “initiating device” refers to a device initiating a communication session, and the term “receiver” or “receiving device” refers to a device to which the communication session is directed.

Using conventional technology, a user of an initiating device attempting to reach another at a receiving device (represented by a “contact” or “contact information” in the iii initiating device) via a communication session is required to manually look-up and determine the local time of the receiving device and determine if it is an appropriate time (e.g., business hours, etc.) to initiate contact with that device. This is generally performed, for example, by accessing the contact information corresponding to the receiving device and using at least a portion of the contact information (e.g., area code, city code, country code, zip code, etc.) to determine the local time of the receiving device. The challenges under the conventional technology include, for example: cumbersome to look up a contact's local time, especially given that each contact may have a different set of available parameters that can be used; error prone since at any point in the process the user could make a mistake and determine the wrong local time for the contact; time consuming to perform the look up manually. These challenges are exacerbated if the user engages in frequent long-distance or international communication sessions (e.g. calls).

The systems and methods of an embodiment, also referred to herein as “Whitespace” or alternatively as “Meetyor” and/or “CallOrNot”, use the available information of a receiver and/or contact to determine its current time zone instead of the conventional manual look-up process described herein. The application or methods of an embodiment, also referred to herein as the “alerting application”, uses local contact information (e.g., stored on the initiating device) and/or data received from the receiving device to provide one or more of rapid and reliable lookup of the actual local time at the target device, peace of mind when contacting someone in a different time zone, or when someone is traveling, time savings, especially when contacting long-distance frequently, and accurate local time of the contact even if they're on the road (if opted in to provide their real-time location or time zone).

In the following description, numerous specific details are introduced to provide a thorough understanding of, and enabling description for, the systems and methods described. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

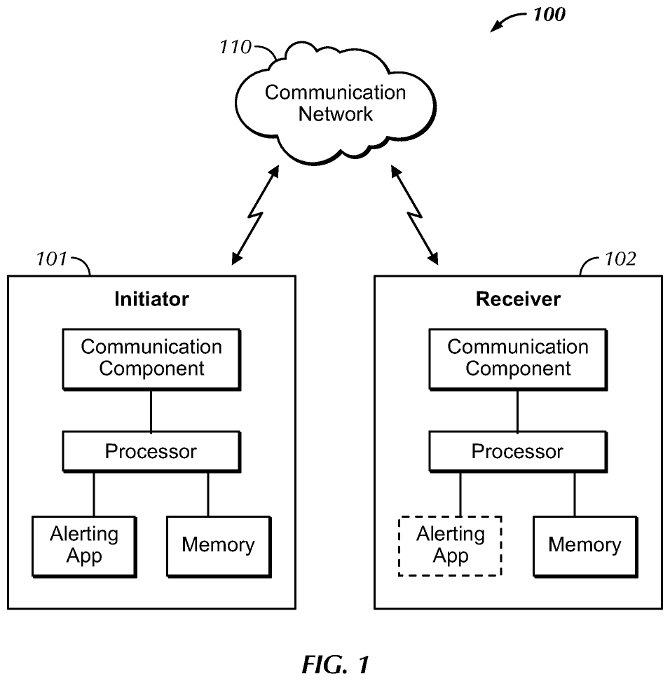

FIG. 1 is a block diagram of a system 100 including the alerting application, under an embodiment. The system 100 includes an initiator 101 (i.e., initiating device 101 under control of a session initiator or caller (not shown)) coupled to a receiver 102 (i.e., receiving device 102 under control of a called party or “contact” (not shown)). The initiator 101 is coupled to the receiver 102, at least during the period of a session, via one or more communication networks 110. The initiator 101 comprises the alerting app executing or running on a processor, and the processor is coupled to a communication component and a memory device. The alerting app comprises one or more of a stand-alone application, a component or module of one or more other applications or software programs, and an embedded application or program, for example, but is not so limited. The receiver 102 comprises a processor coupled to a communication component and a memory device and, optionally, includes the alerting app executing or running on the processor. The alerting app is hosted on a host device when the alerting app is downloaded or otherwise installed on the host device, or when the alerting app is a component of another application or program hosted or installed on the host device.

The presence of the alerting app on the receiver is optional as described above. When the alerting app is installed on the initiator but is not present on the receiver, processes using the alerting app begin when a contact is selected, designated, or otherwise specified at the initiator. The alerting app performs a lookup of the local time zone of the selected contact using any combination of area code, city code, country code, zip code, address, etc. The lookup of an embodiment uses at least one of a locally stored or coupled database, or a remote database or other application coupled (e.g., web-based, app-based, server-based, etc.) to the initiator.

Alternatively, the alerting app performs a lookup of the local time zone of the selected contact using information or data derived or received from social media apps and/or platforms. For example, the alerting app uses data from information posted by a contact on social media platforms. As another example, the alerting app uses data (e.g., metadata, etc.) derived from recent emails from the contact.

Upon determining the local time zone of the selected contact, the alerting app applies any necessary adjustment or correction (e.g., apply daylight savings information, etc.) to the contact's local time zone, and determines the contact's local time via a time zone database hosted on or coupled to the initiator. The alerting app of an embodiment presents the contact's local time within the receiver's communication application (e.g., telephone app, messaging app, web conferencing software, etc.). If the contact has optionally specified an alert time window (e.g. 8 am-6 pm) during which contact is desired, the alerting app further notifies the initiator based on this information (e.g., that contact is about to be initiated outside of the desirable time window, etc.). The alerting time window can also be set by default by the system, with the ability for it to be changed by the contact at any time.

As an optional feature of the alerting app of an embodiment, the receiver, while travelling outside of its normal location of residence, can optionally choose to provide its actual (real-time) time zone or location, either manually or automatically via its communication system. The provided time zone or location information is provided directly to the initiator or, alternatively, via at least one intermediate device. In this manner, the initiator is provided with accurate position or location information when the contact is actually “roaming”. Note that a contact may optionally provide geographically-constrained information from which its time zone can be determined (e.g., time zone, city, state, difference relative to Greenwich Mean Time (GMT), etc.) instead of actual position or location information, for privacy reasons.

When the alerting app is installed on both the initiator and the receiver devices, processes at the initiator using the alerting app begin when a contact is selected, designated, or otherwise specified at the initiator. Under this embodiment, the alerting apps on each of the initiator and receiver devices exchange data regarding current location, meaning that the initiator includes up-to-date information on the receiver's location. The location information exchanged may be limited based on a geographical constraint (e.g., time zone, city, state, difference relative to Greenwich Mean Time (GMT), etc.) for privacy reasons. The information is exchanged directly and/or through a proxy server, gateway, or other hosted service, but is not so limited.

The alerting app uses the information received from the alerting app of the receiver device to determine the actual time zone of the selected contact. This function may comprise nothing more than evaluating actual location information to determine time zone at that location, or using any difference information of the geographically-constrained data to calculate the time zone.

Upon determining the local time zone of the selected contact, the alerting app applies any necessary adjustment or correction (e.g., apply daylight savings information, etc.) to the contact's local time zone, and determines the contact's local time. The alerting app of an embodiment presents the contact's local time within the receiver's communication application (e.g., telephone app, messaging app, web conferencing software, etc.). If the contact has optionally specified an alert time window (e.g. 8 am-6 pm) during which contact is desired, the alerting app further notifies the initiator based on this information (e.g., that contact is about to be initiated outside of the desirable time window, etc.).

The embodiments described herein, upon determining the local time zone of the selected contact, present the contact's local time within the receiver's communication application, but the embodiment is not so limited. As an alternative to presenting the contact's local time at the initiator, the alerting app of an alternative embodiment presents a message at the initiator that informs the user that it is not appropriate to attempt to establish communication with the contact at the current time, but does not present the contact's local time. In another alternative embodiment, the alerting app blocks or prevents the initiator from attempting to establish communication with the contact at the current time, and presents a message at the initiator that informs the user that it is not an appropriate time to communicate with the contact, but again does not present the contact's local time.

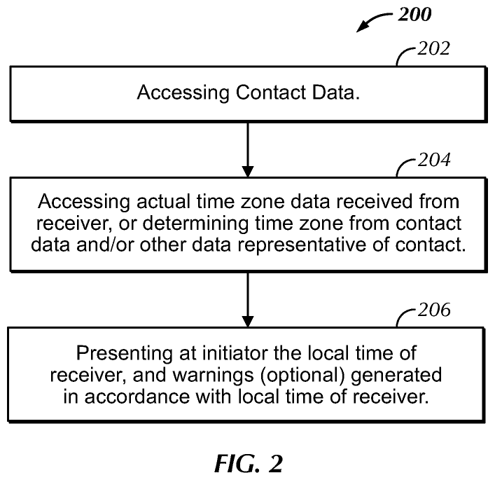

FIG. 2 is a flow diagram 200 of processes of the alerting application, under an embodiment. Generally, the alerting app accesses contact data of a selected contact 202. Using the selected contact data, the alerting app accesses the current time zone data received from the receiver, or determines the current receiver time zone from contact data and/or other data representative of contact 204. The alerting app presents at initiator the current local time of the receiver and, optionally, any warnings generated in accordance with the local time of receiver 206.

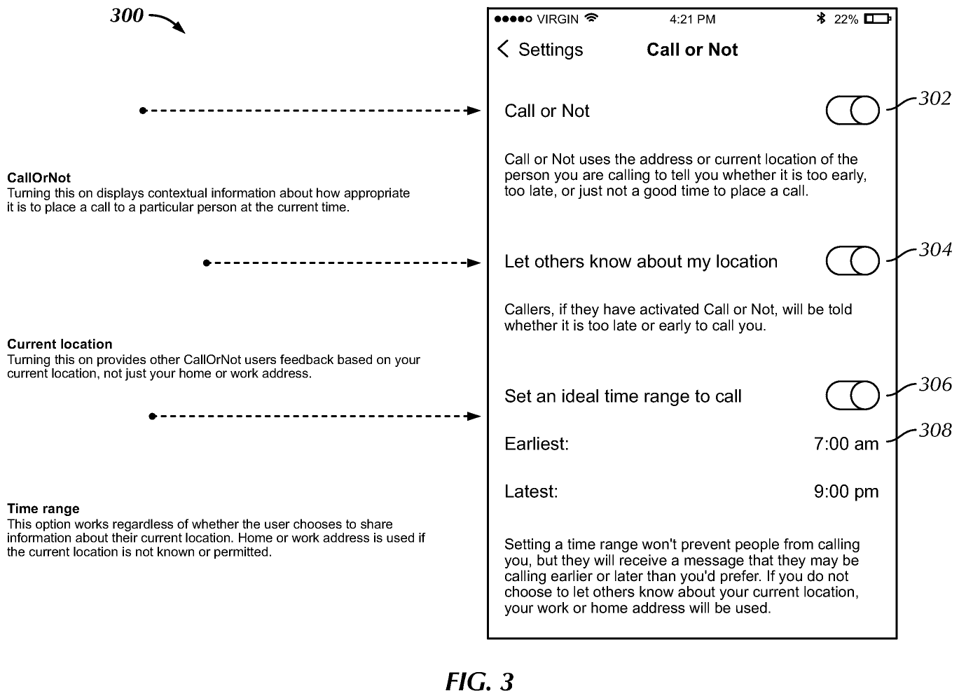

FIG. 3 is an example user interface (UI) 300 for controlling Whitespace settings, under an embodiment. The settings of an embodiment include a Whitespace setting control 302, a location setting control 304, and time range setting controls 306 and 308, but are not so limited. The Whitespace setting control 302 controls a state of Whitespace, and activation of the Whitespace setting control 302 enables display of contextual information as to appropriateness of placing the initiated call to the particular called party at the current time.

The location setting control 304 controls a location used by Whitespace in determining an appropriate time of a call. Activation of the location setting control 304 enables a caller to see the current time at the actual geographical location of the called party. When the location setting control 304 is deactivated, a caller is prevented from seeing the current time at the actual geographical location of the called party and, instead, is presented a time based on contact information of the called party in the caller's device.

The time range setting controls 306 and 308 include a time range activation control 306 and a time setting control 308. The time range activation control 306 controls a state of the time range notification function. Consequently, activation of the time range activation control 306 enables display of an ideal time range for receipt of a call as established by the called party. The time setting control 308 enables a user to set or input times (e.g., earliest, latest, etc.) establishing a time range or period during which he/she wishes to receive calls. The time setting control 308 is functional regardless of whether a user chooses to share information about his/her current location, and the time range appropriate for calls is determined based on contact information of the called party in the caller's device.

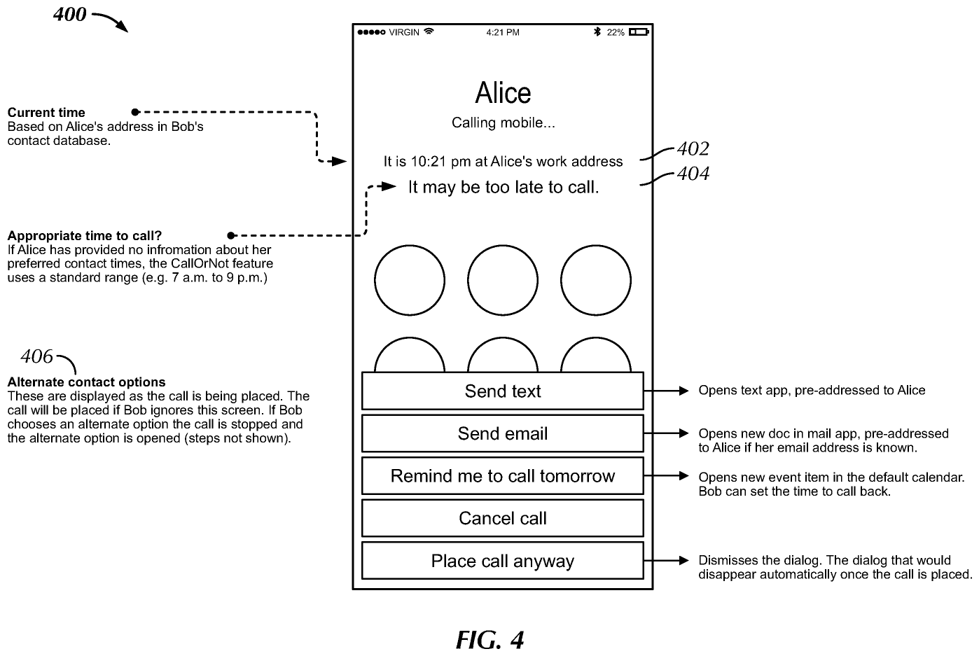

FIG. 4 is an example user interface 400 of a use case involving Whitespace, under an embodiment. In this example use case, a caller will get differing amounts of feedback about whether the call should be placed or not depending on the called party's Whitespace settings, which include not giving permission for other people to know a current location of the called party. Users of the Whitespace feature can see the current time of at least one address of the people they are calling. This allows a Whitespace user to decide whether to place a call at the moment or connect via some other medium. Users of Whitespace can choose to share information about their actual current location to provide even more accurate information to callers about their current time.

In this example use case, Bob needs to call Alice. Bob will get via his client device different amounts of feedback about whether the call should be placed based on the Whitespace settings on Alice's client device. Bob has activated Whitespace and he knows Alice's primary address (e.g., work address, home address, etc.). In this example, Alice does NOT give permission for other people to know her current location and Alice has selected the appropriate settings in the Whitespace application. Also, Alice may not be using the Whitespace feature in which case her current location would not be available to callers. Therefore, the Whitespace application uses the current time 402 for Alice based on Alice's address in Bob's contact database.

Based on the current time determined for Alice, the Whitespace application displays whether the time is appropriate for a call to be placed. If Alice has specified in her settings appropriate times for receiving calls then the appropriate message 404 regarding a call is displayed according to that setting; otherwise if Alice has provided no information about her preferred contact times, Whitespace uses a standard time or range of times (e.g. 7 AM to 9 PM, 9 AM to 5 PM, etc.).

As the call is being placed at Bob's device, alternate contact options 406 are displayed. The call continues being placed if Bob ignores the alternate contact options 406. If Bob selects one of the alternate options to initiate contact with Alice (e.g., send text message, send electronic mail (email), reminder to call at another time, cancel call, place call anyway, etc.), the call is terminated and the alternate contact option is opened or initiated. The alternate contact options upon termination of the call, for example, io include Whitespace opening the text application and generating a text message template pre-addressed to Alice, opening the email application and generating an email message template pre-addressed to Alice, opening the calendar application and generating a calendar event to call Alice, and taking no action.

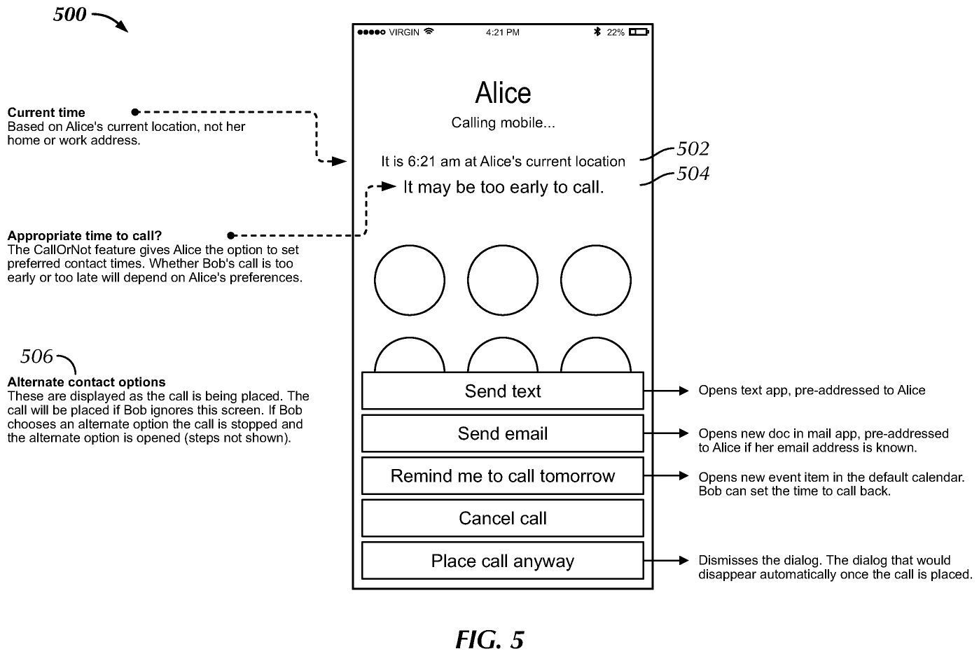

FIG. 5 is an example user interface 500 of another use case involving Whitespace, under an embodiment. A caller is presented differing amounts of feedback about whether the call should be placed or not depending on the called party's Whitespace settings, which include giving permission for other people to know a current location of the called party. In this example use case, the called party has elected to share information about their actual current location in order to provide even more accurate information to callers about their current time. Under this scenario, the calling party using Whitespace is presented the current time of called party based on the actual location of the called party. This allows a Whitespace user to decide whether to place a call at the moment or connect via some other medium.

In this example use case, Bob is placing a call to Alice. Bob will get via his client device different amounts of feedback about whether the call should be placed based on the Whitespace settings on Alice's client device. Bob has activated Whitespace and he is presented with the current time 502 at Alice's actual geographical location because Alice has selected the appropriate settings in the Whitespace application to enable callers to see her actual location. Based on the current time at Alice's actual location, Whitespace displays whether the time is appropriate for a call to be placed. If Alice has specified in her settings appropriate times for receiving calls then the appropriate message 504 regarding a call is displayed according to that setting; otherwise if Alice has provided no information about her preferred contact times, Whitespace uses a standard time or range of times (e.g. 7 AM to 9 PM, 9 AM to 5 PM, etc.).

As the call is being placed at Bob's device, alternate contact options 506 are displayed. The call continues being placed if Bob ignores the alternate contact options 506. If Bob selects one of the alternate options to initiate contact with Alice (e.g., send text message, send electronic mail, reminder to call at another time, cancel call, place call anyway, etc.), the call is terminated and the alternate contact option is opened or initiated. The alternate contact options upon termination of the call, for example, include Whitespace opening the text application and generating a text message template pre-addressed to Alice, opening the email application and generating an email message template pre-addressed to Alice, opening the calendar application and generating a calendar event to call Alice, and taking no action.

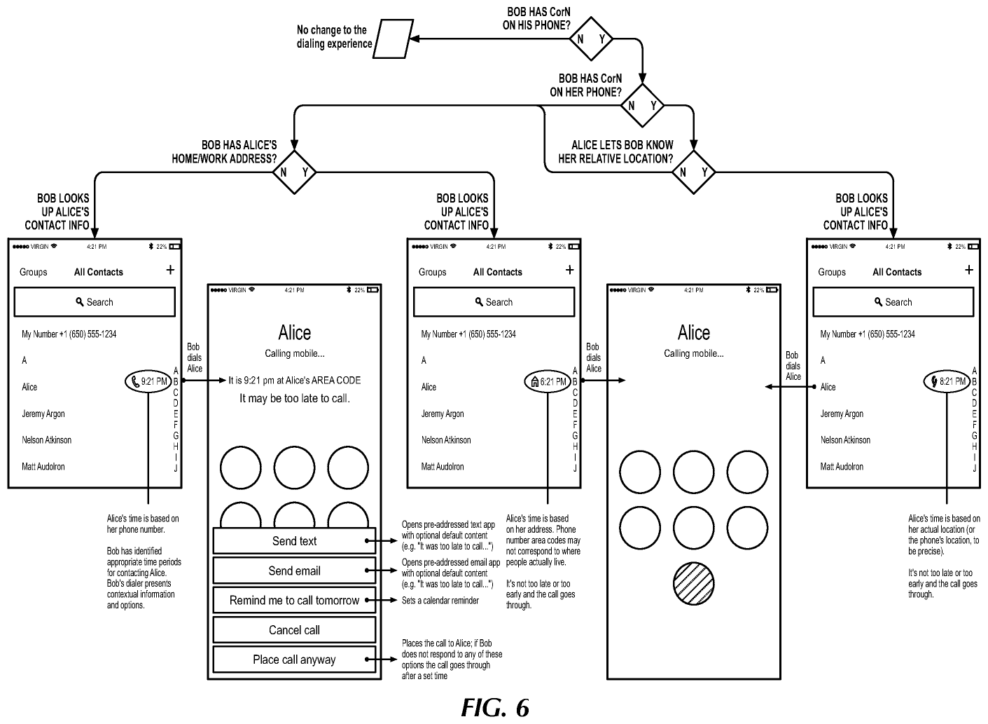

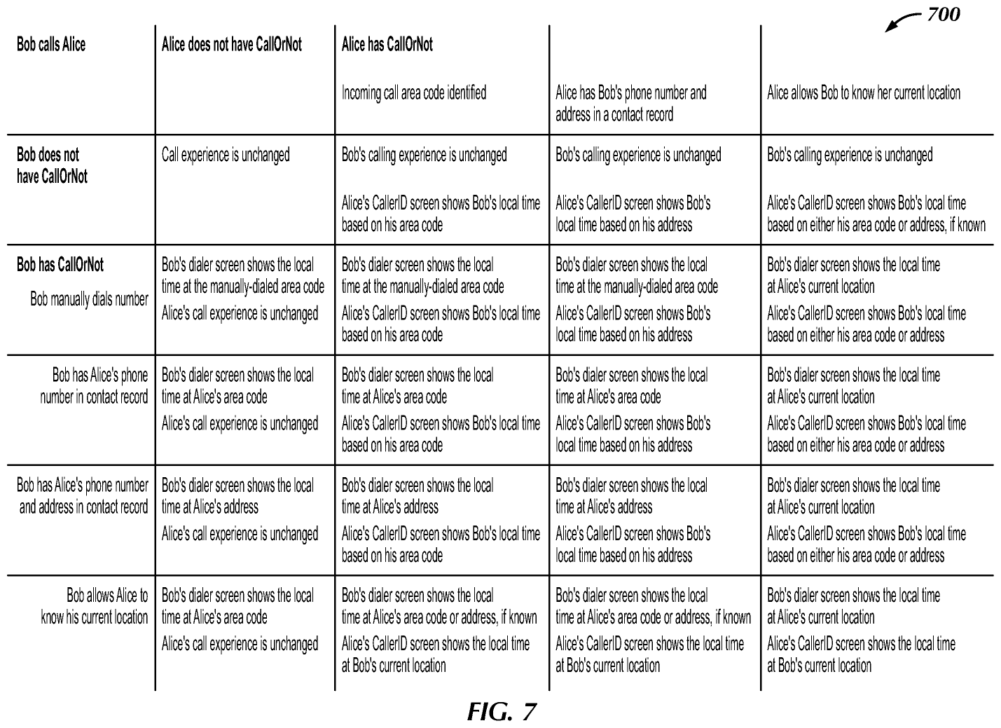

Continuing with examples in which Bob calls Alice, FIG. 6 shows example interactions 600 comprising one or more components of Whitespace, under an embodiment. FIG. 7 is a table 700 of state conditions and corresponding interactions 600 comprising one or more components of Whitespace, under an embodiment. For these example interactions, Bob lives in San Francisco (6:21 PM), has a device assigned a San Francisco area code (6:21 PM), and is currently located in Hawaii (3:21 PM). Alice lives in San Francisco (6:21 PM), has a device assigned a New York area code (9:21 PM), and is currently located in Chicago (8:21 PM). Whitespace provides information to Bob's communication applications about the local time of Alice, the person with whom he is attempting contact, and the provided information enables Bob to decide whether to complete a real-time call or to estimate the time the contact may respond to a text or email. As described in detail herein, the Whitespace experience does not require the called party to have Whitespace in order for the parties to the call to benefit.

The Whitespace application surplants the need for real-time communications and meetings required for the establishment and growth of successful business processes and personal relationships. Real-time communications require two or more people to agree to meet, agree on a day/time for the meeting, and agree on a location or means (e.g., phone) by which the meeting is to be conducted. Embodiments of the Whitespace application described herein integrate platform-level services and applications to speed the scheduling of real-time communications by integrating contact information (e.g., area codes, addresses, etc.), location or position data (e.g., GPS-based data, etc.) (opt-in), and calendars (opt-in) with other communication services (e.g., phone, email, text messages, etc.).

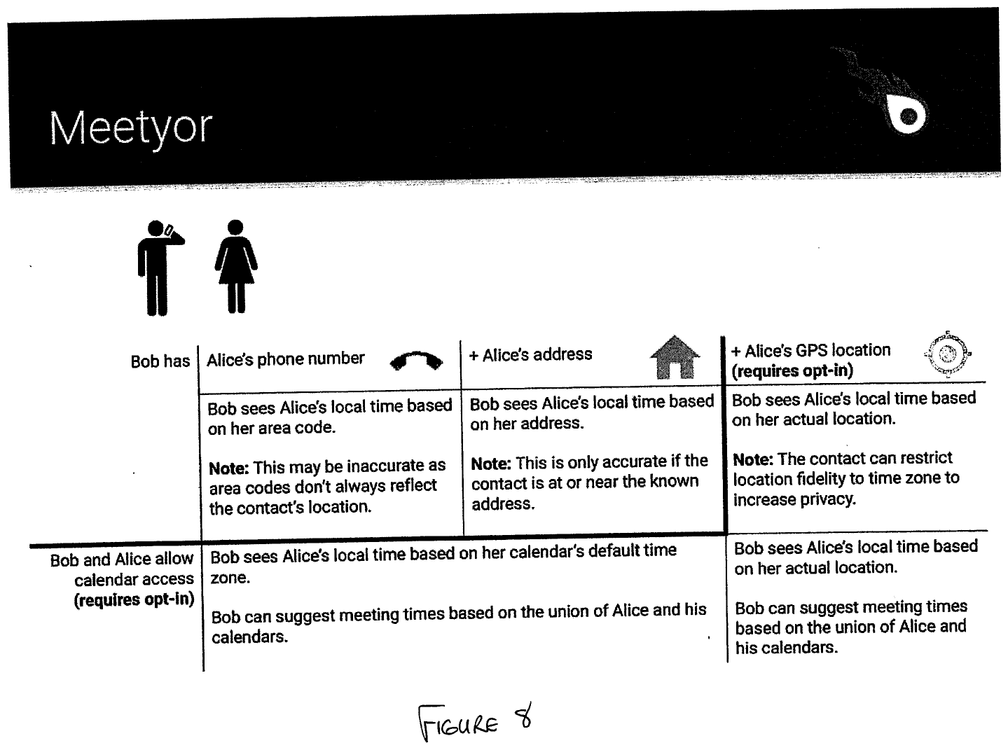

Basic functionality of Whitespace does not require participant opt-in. Greater accuracy uses GPS location information sharing, but other positioning technologies can be used. FIG. 8 is an operational matrix showing communication scheduling with Whitespace, under an embodiment. The legend for this matrix includes a “telephone” icon representing phone numbers and area codes of a party to be contacted (e.g., Alice) are known by an initiator (e.g., Bob), a “house” icon representing physical addresses (e.g., work, home, etc.) are known by the initiator, and a “target” icon representing actual current time zone or location of the party to be contacted is known by the initiator.

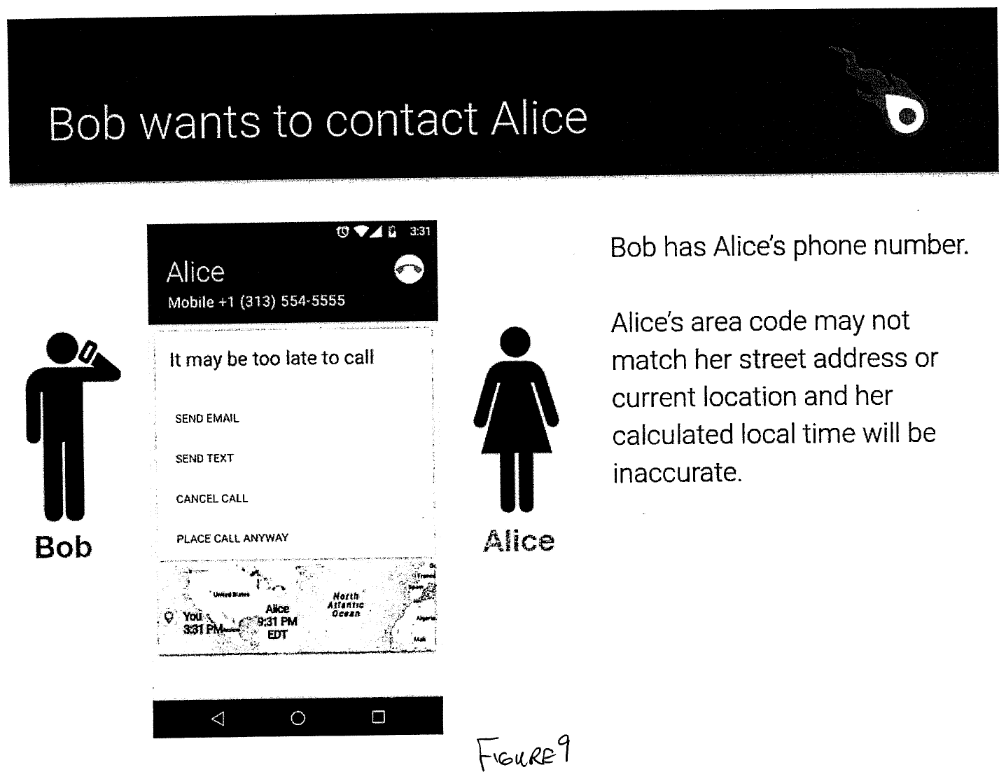

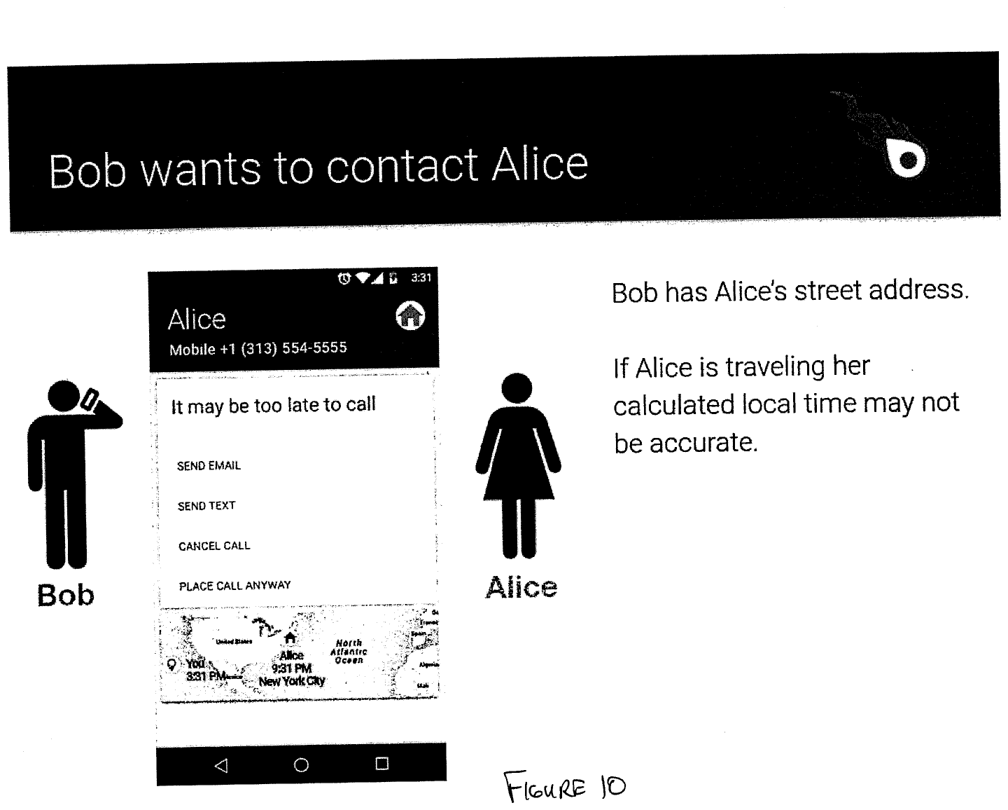

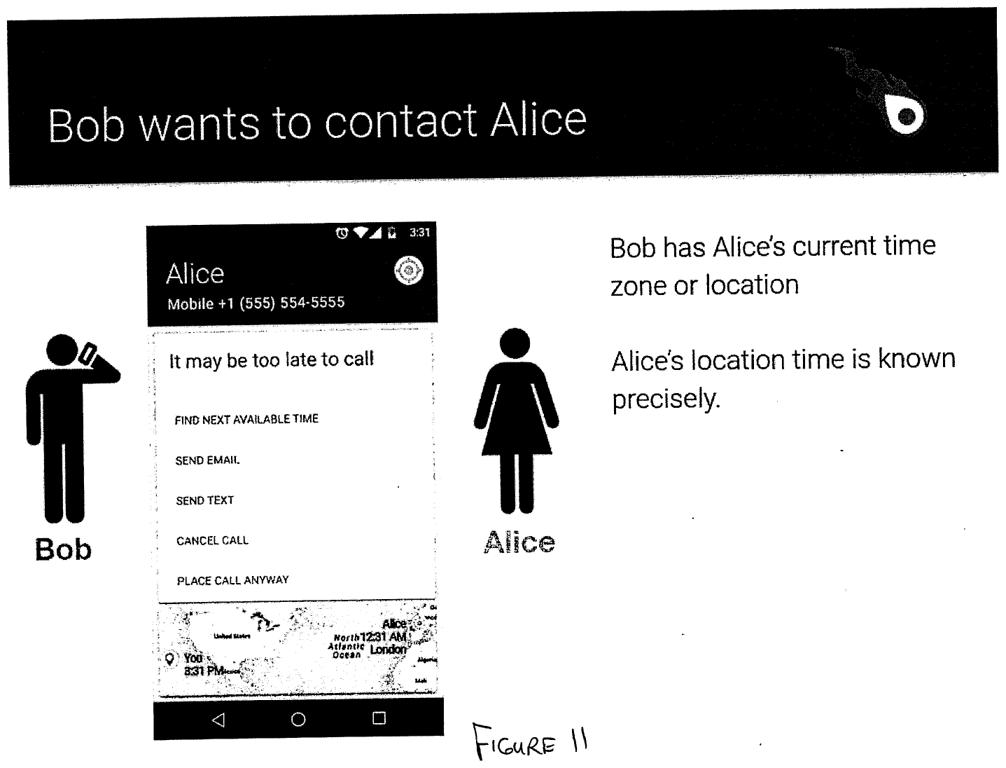

FIG. 9 shows an operational example with sample UI when initiator has the telephone number of the party to be contacted, under an embodiment. FIG. 10 shows an operational example with sample UI when initiator has the street address of the party to be contacted, under an embodiment. FIG. 11 shows an operational example with sample UI when initiator has the actual current time zone or location of the party to be contacted, under an embodiment.

Two example scenarios involving Whitespace are presented below. These scenarios involve a phone call placed to someone unlikely to answer due to their local time, and an email leading directly to a calendar request between multiple participants.

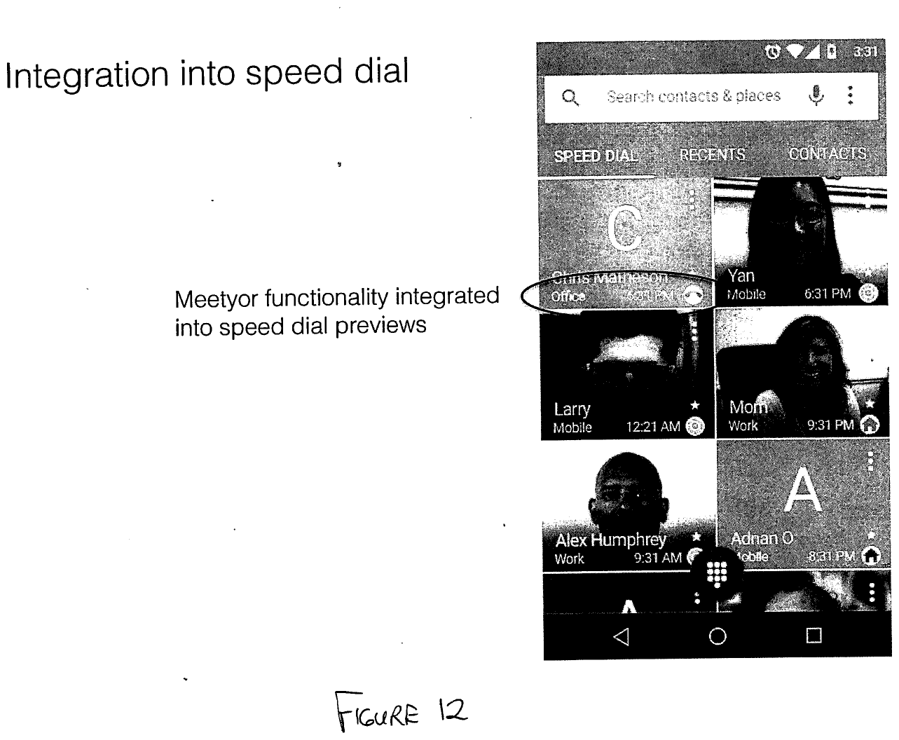

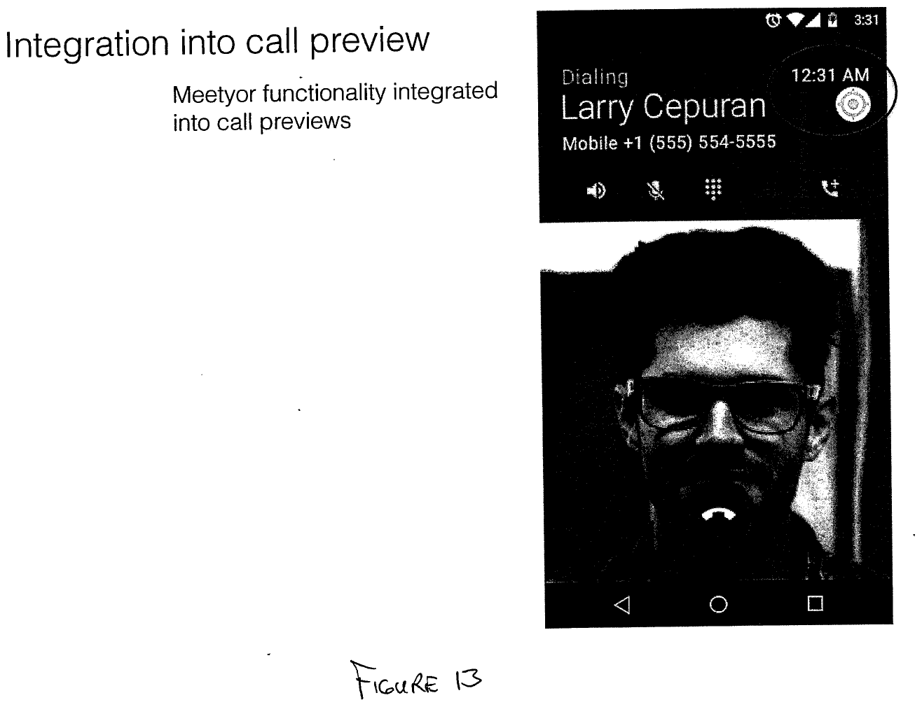

FIG. 12 shows integration of Whitespace functionality into speed dial previews, under an embodiment. The speed dial preview for “Larry Mobile” includes the Whitespace “target” icon indicating information of Larry's current time zone or location is known. Upon selection of the speed dial icon for “Larry Mobile”, FIG. 13 shows contact page for “Larry” including the Whitespace “target” icon, under an embodiment. Selection of the “target” icon on Larry's contact page results in presentation of contact options for Larry.

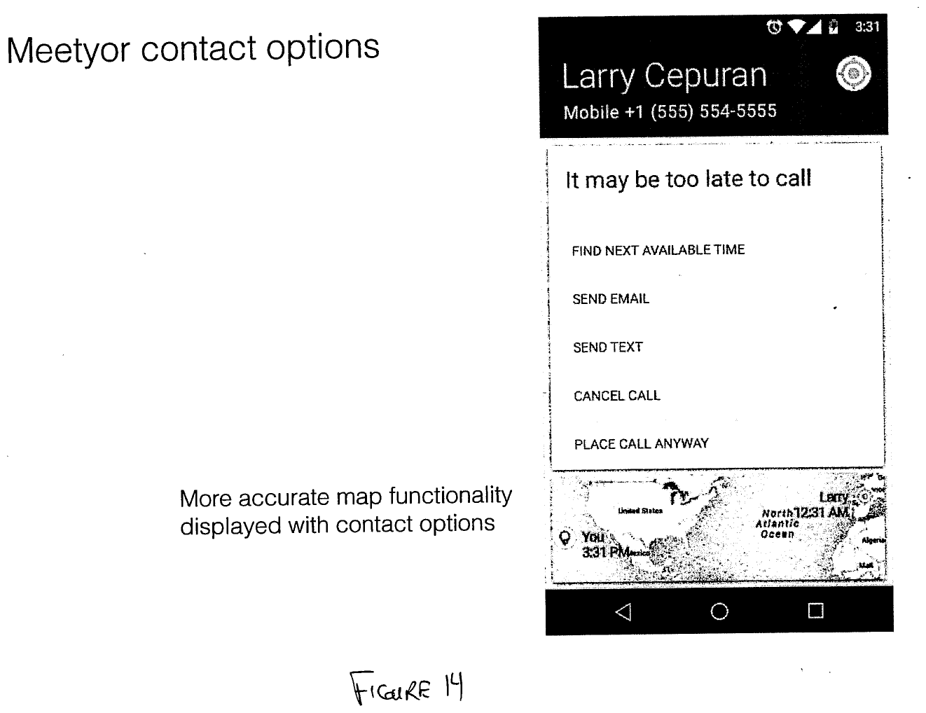

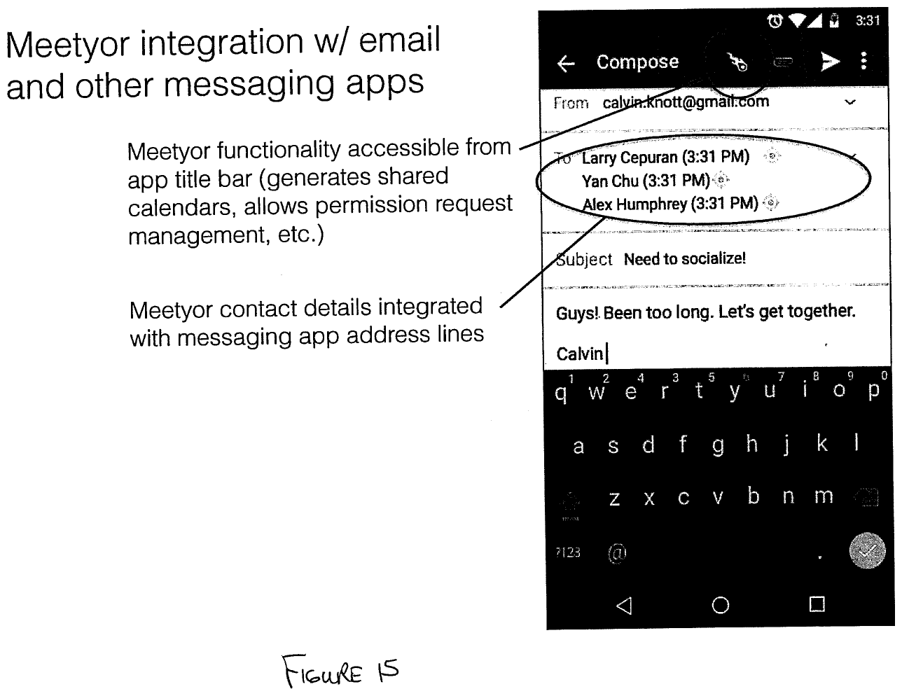

FIG. 14 is an example UI contact options page for “Larry” including the Whitespace “target” icon, under an embodiment. The contact options presented for Larry include an option to “SEND EMAIL”, and selection of the icon corresponding to “SEND EMAIL” results in presentation of an email template on the UI. The email template of an embodiment is presented via the native email application on the host device, but is not so limited. FIG. 15 is an example email template page triggered by the Whitespace application, under an embodiment. The email template is pre-filled to include the contact's (“Larry Cepuran”) email address, but the embodiment is not so limited. In this example, the user has added “Yan Chu” and “Alex Humphrey” to the list of addresses for the email, and actual current time zone or location is known for both of these addressees as indicated by the Whitespace “target” icon displayed adjacent to their respective names on the email addressee list.

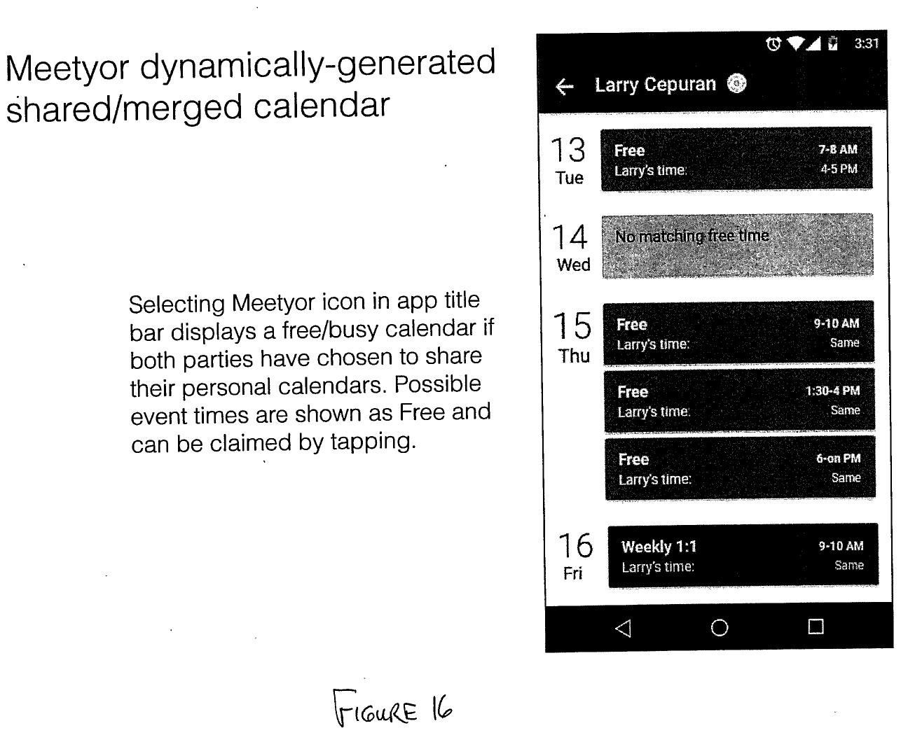

The contact options presented for Larry also include an option to “FIND NEXT AVAILABLE TIME”, and selection of the icon corresponding to “FIND NEXT AVAILABLE TIME” results in presentation of a calendar scheduling interface (shared/merged calendar) on the UI. FIG. 16 is an example calendar scheduling interface triggered by the Whitespace application, under an embodiment. The calendar scheduling interface shows time allocations for Larry over a period of several days, but the embodiment is not so limited. Possible times for scheduling an event with Larry are show via the interface, and a time can be claimed by tapping or selecting a time period indicated as “Free”.

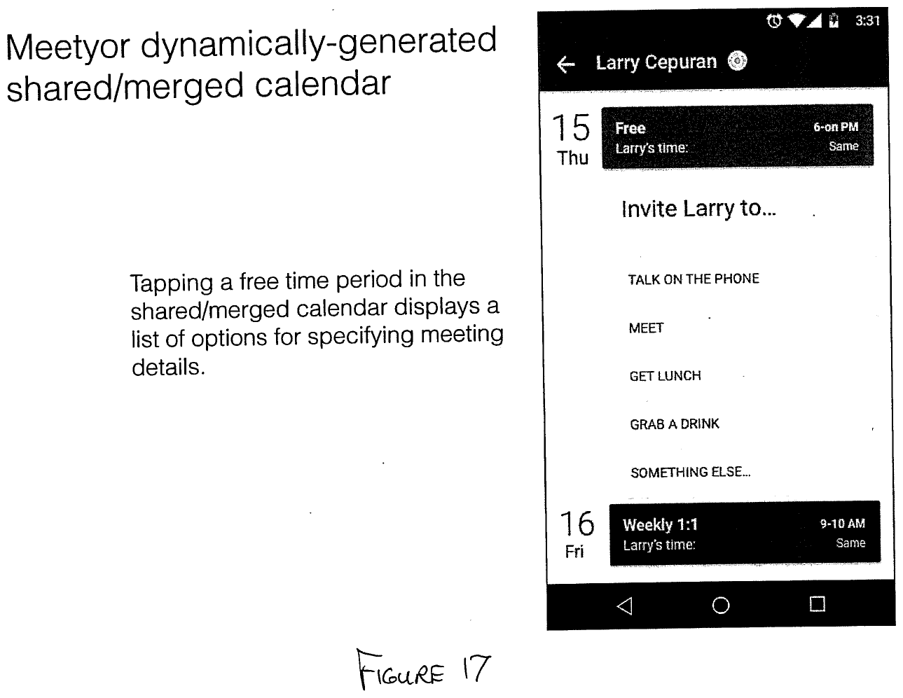

Selecting a “Free” time period at the calendar scheduling interface (e.g., “15 Thu, Free 6-on PM”) results in display of a list of options for specifying meeting details. FIG. 17 is an example options interface triggered by the Whitespace application for selecting meeting details, under an embodiment.

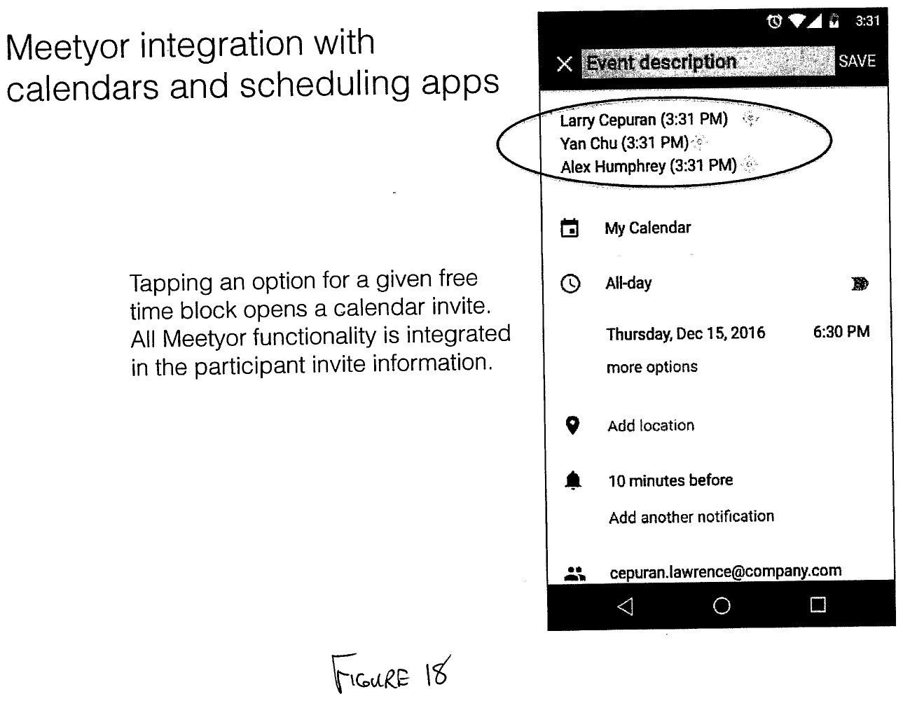

Selecting a meeting details option at the options interface results in display of a calendar invite. FIG. 18 is an example calendar invitation interface triggered by the Whitespace application, under an embodiment. The calendar invitation is pre-filled to include the contact's (“Larry Cepuran”) information, but the embodiment is not so limited. In this example, the user has added “Yan Chu” and “Alex Humphrey” to the invitation, and actual current time zone or location is known for both of these addressees as indicated by the Whitespace “target” icon displayed adjacent to their respective names on the invitation. In this example, the user invited Larry to “MEET” so the “Event description” field of the invitation is blank so that an event description can be added. If the user had opted to invite Larry to “TALK ON THE PHONE”, then the event description field of the invitation would be pre-filled to denote the event as a call (e.g., “Call Larry Cepuran”).

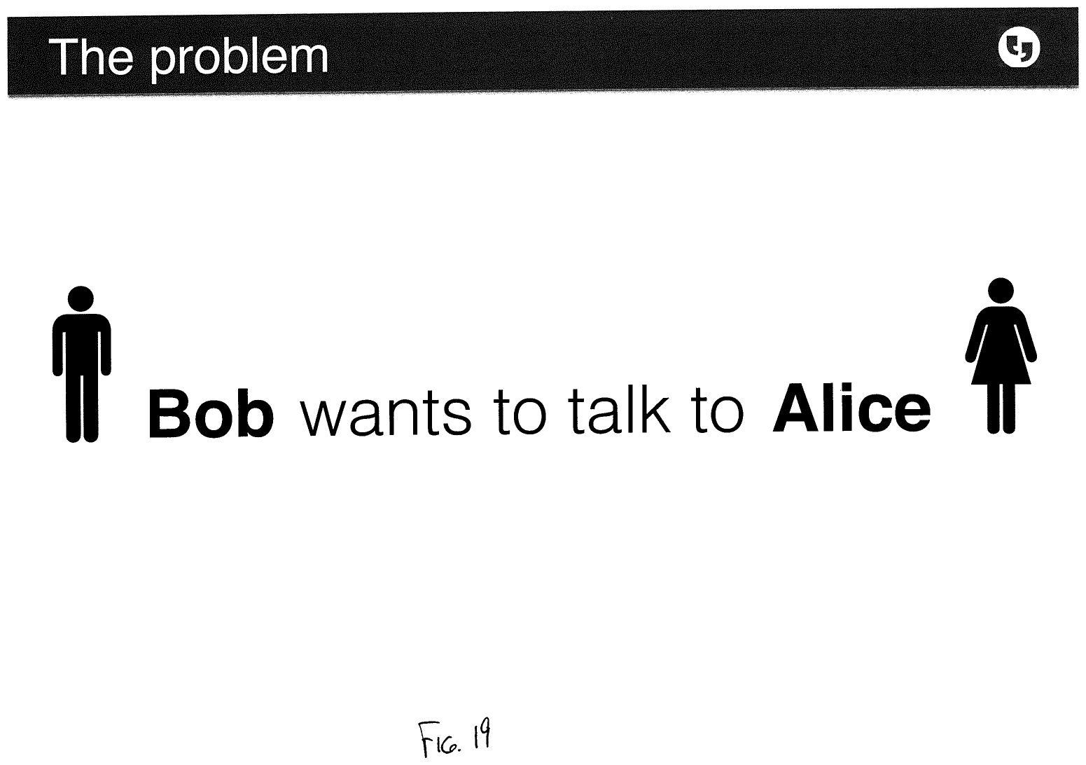

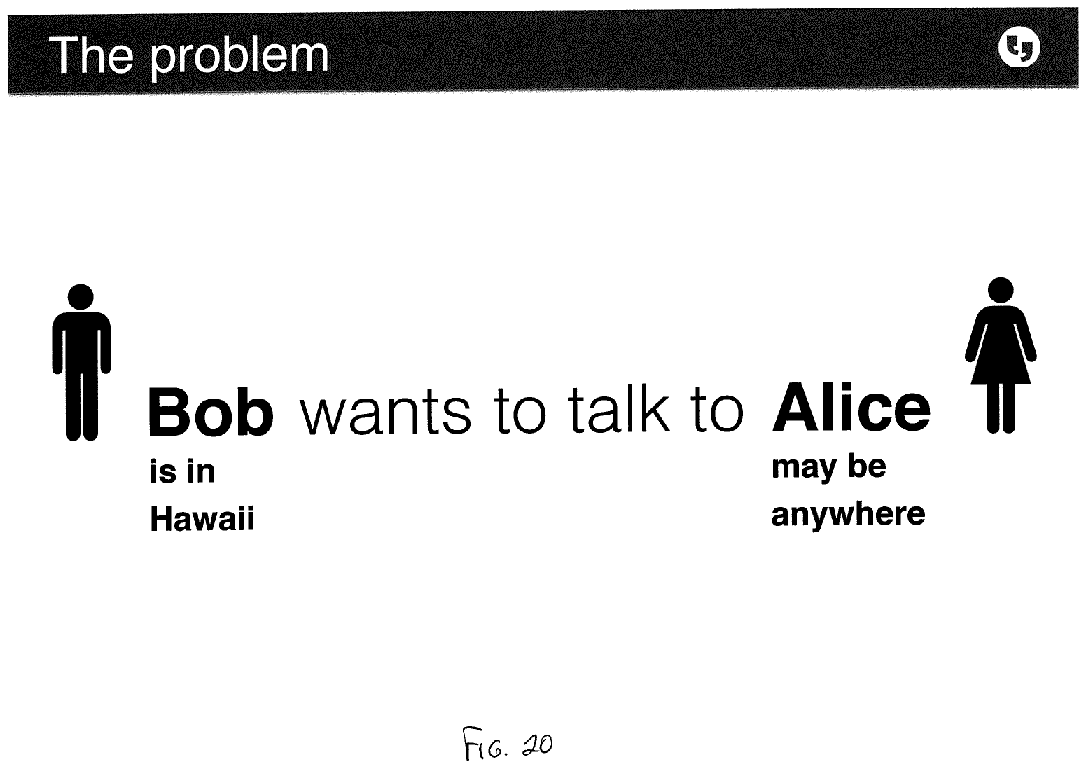

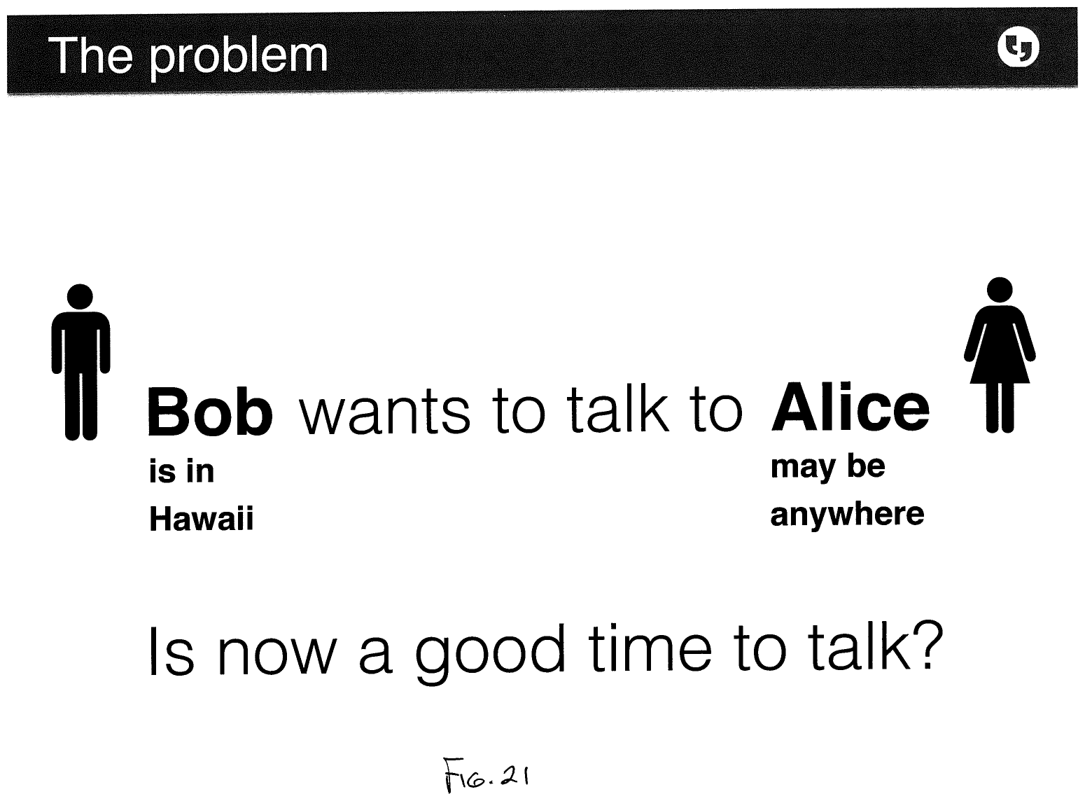

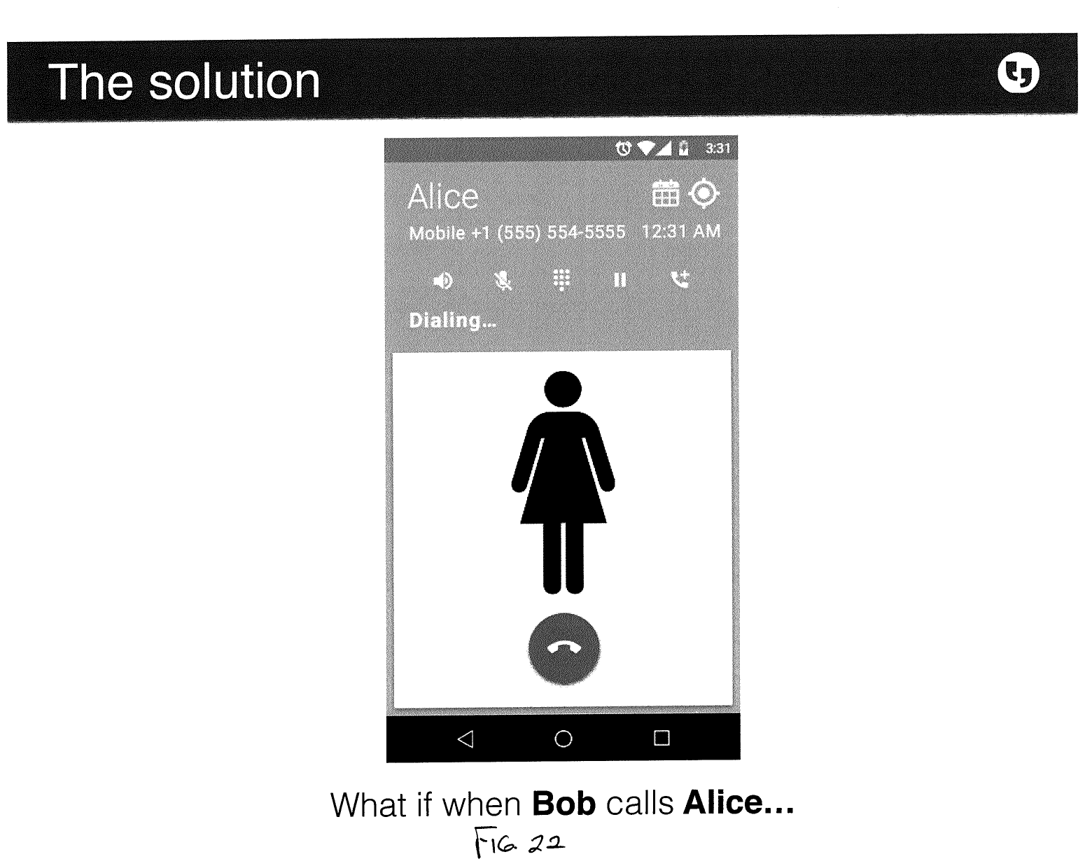

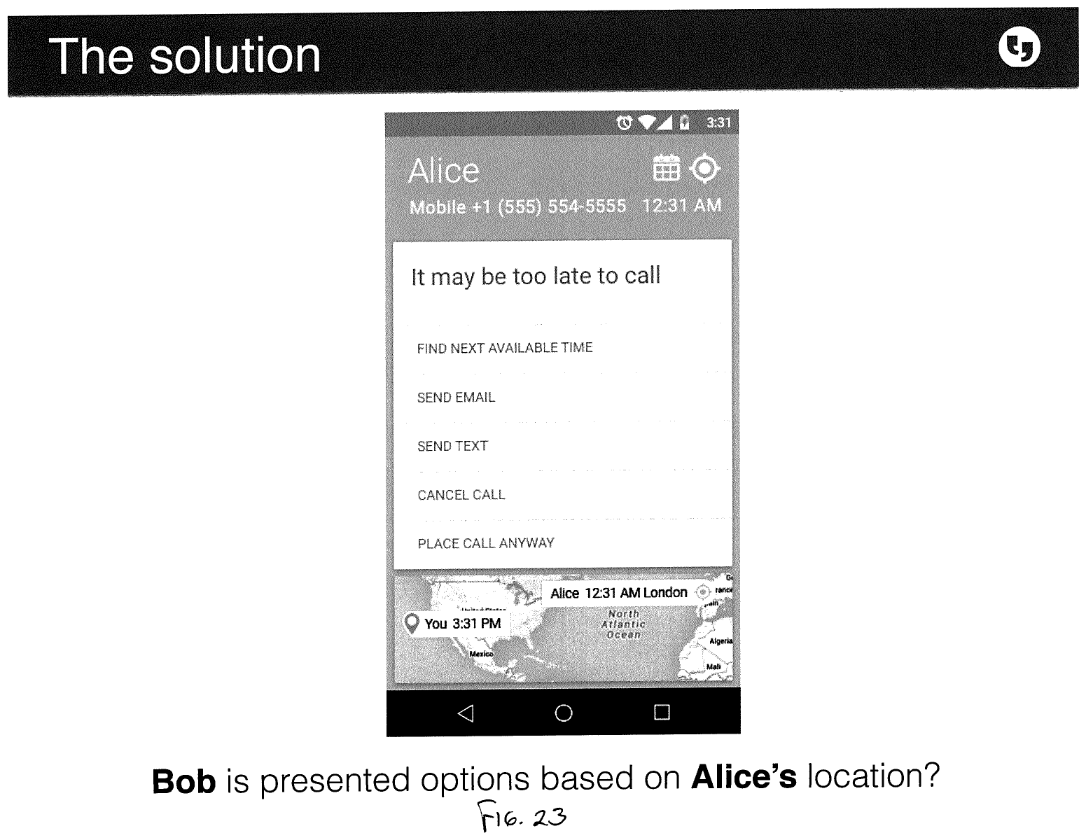

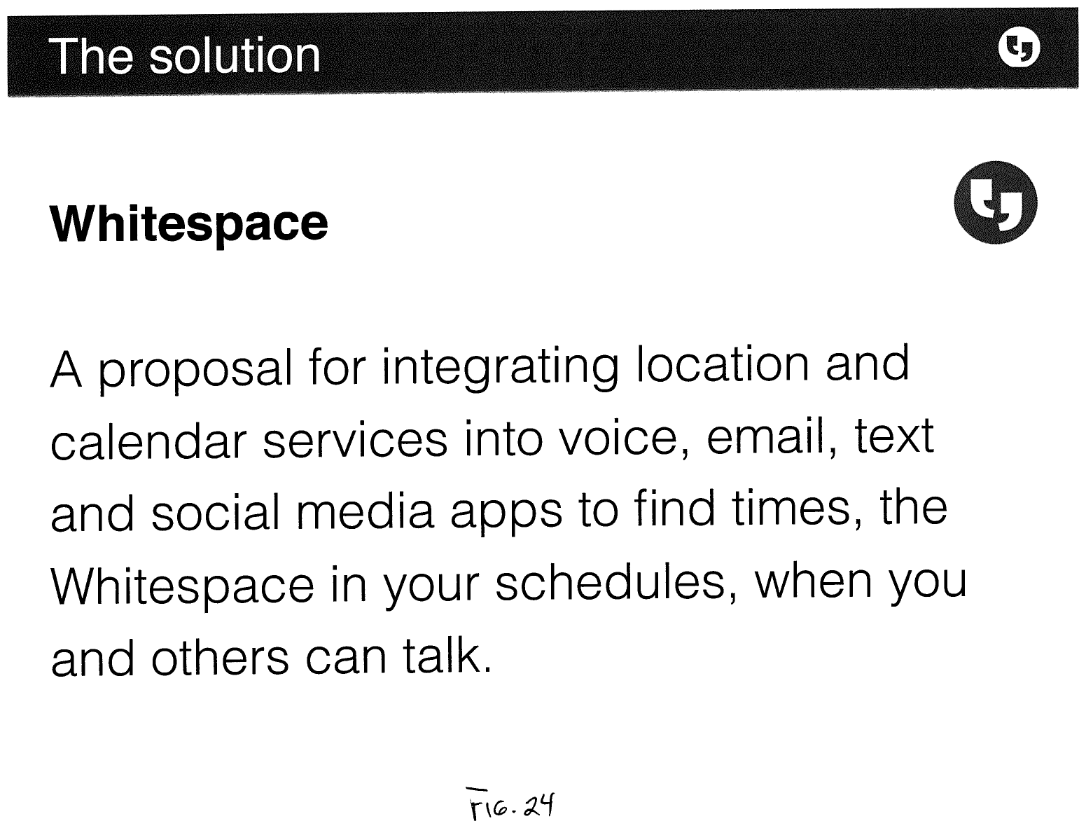

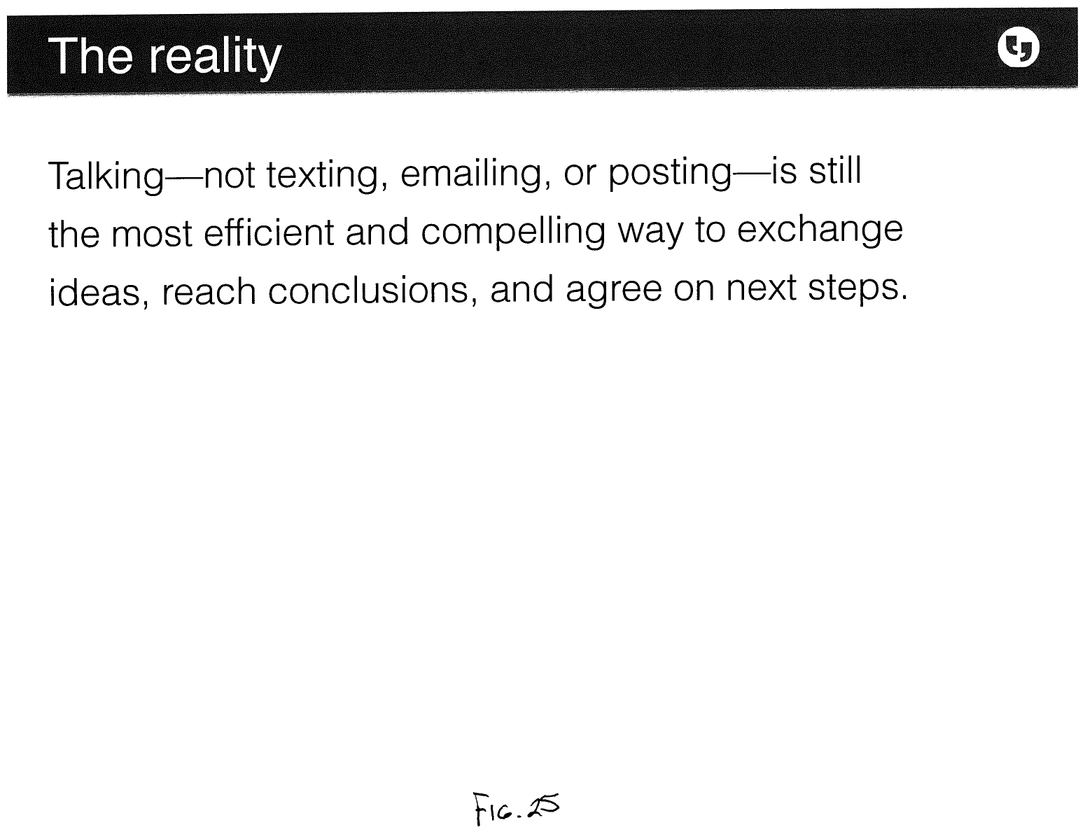

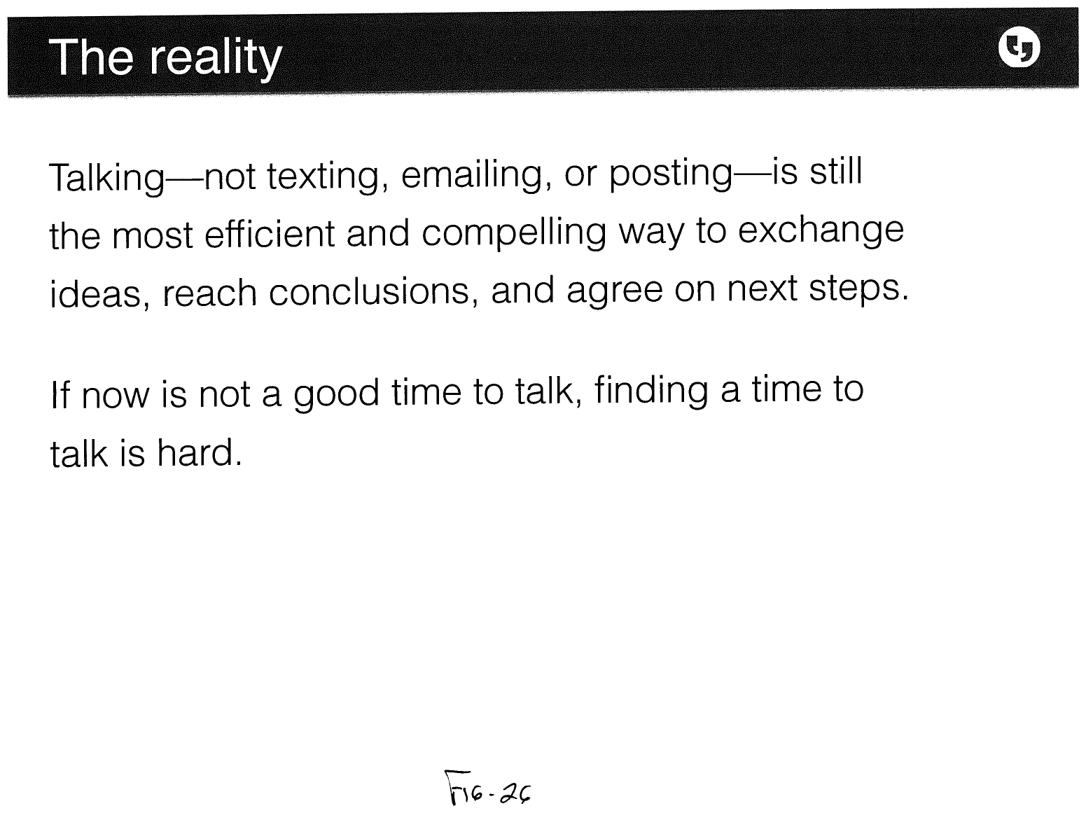

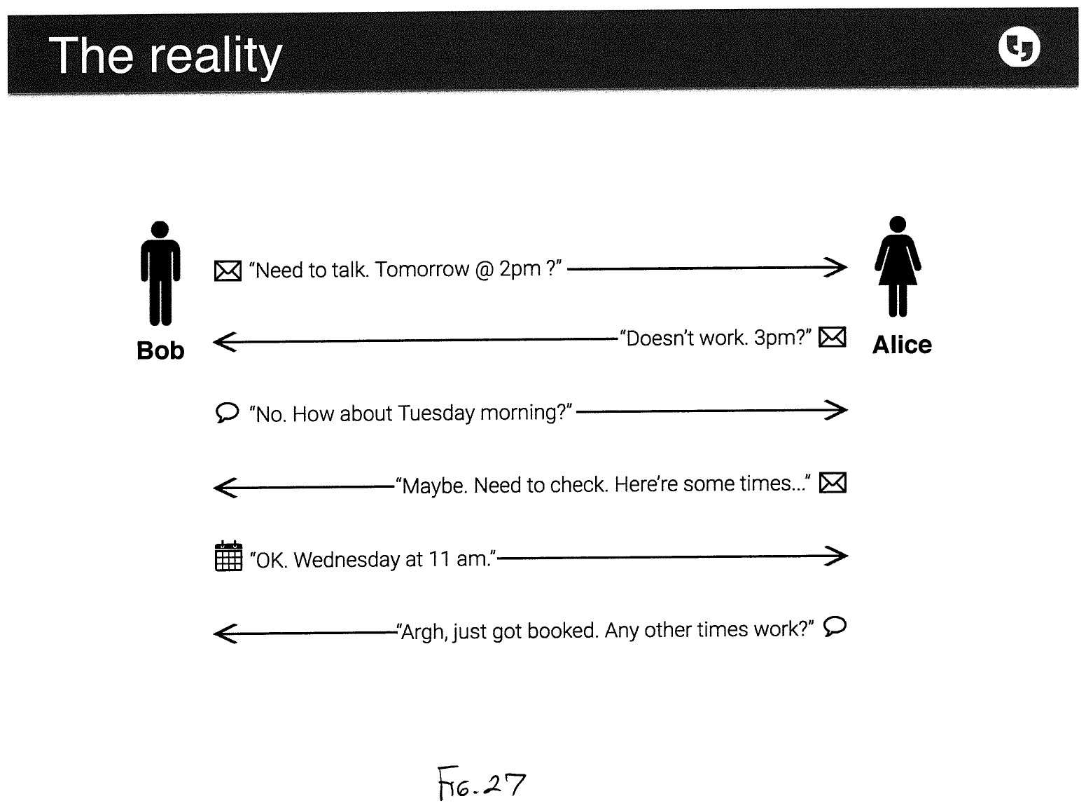

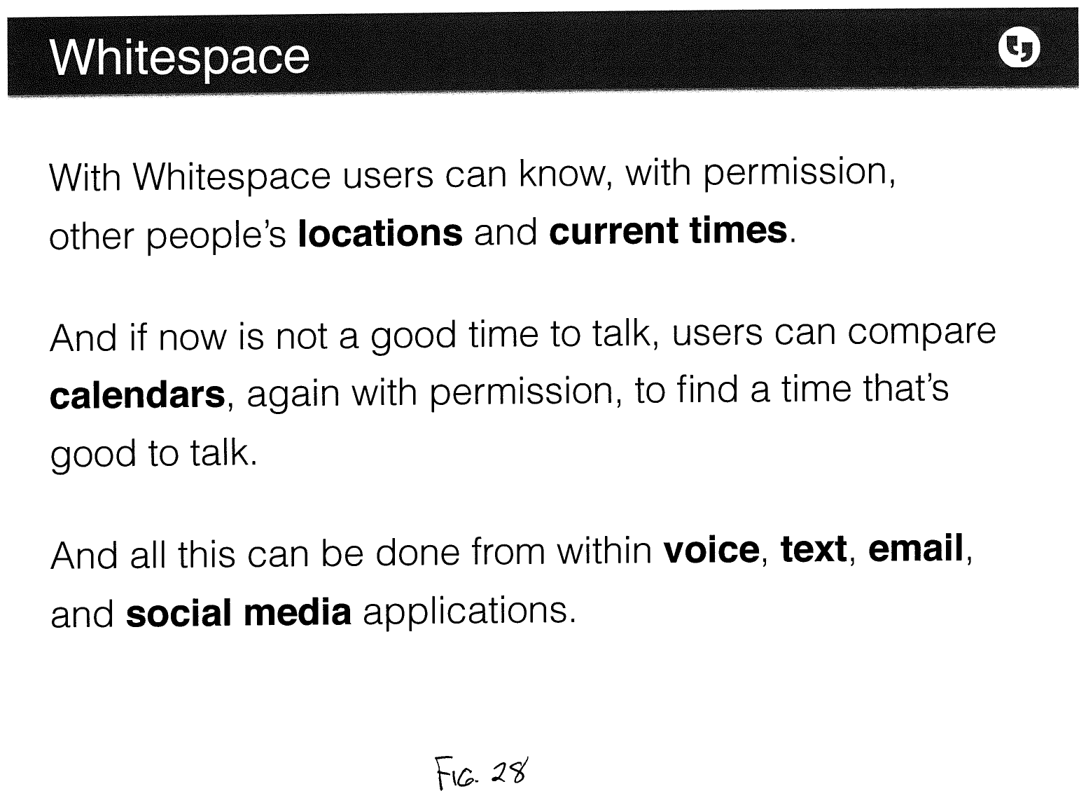

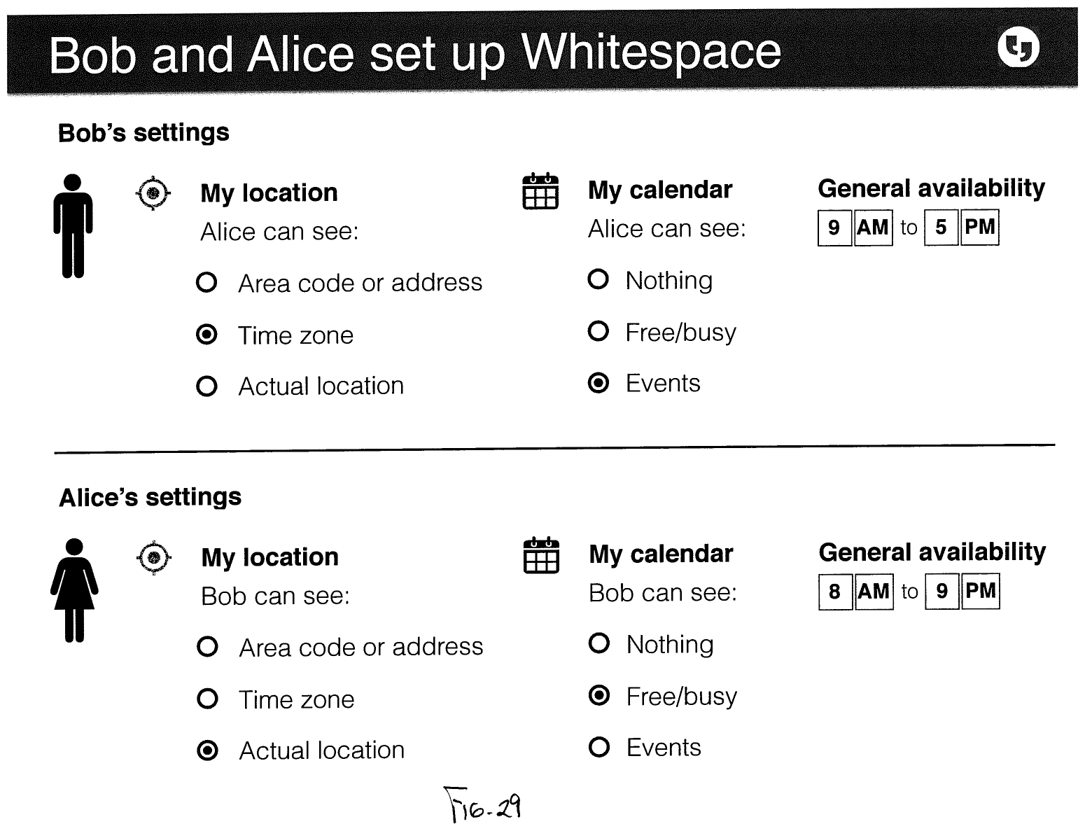

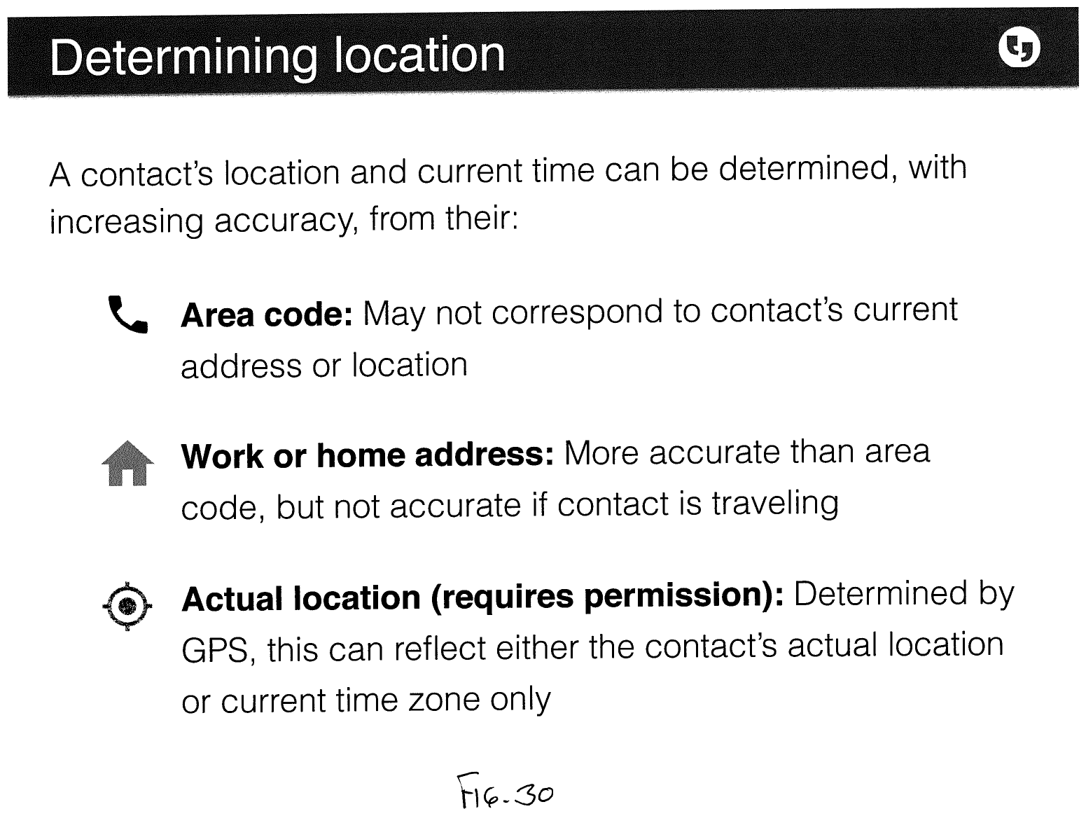

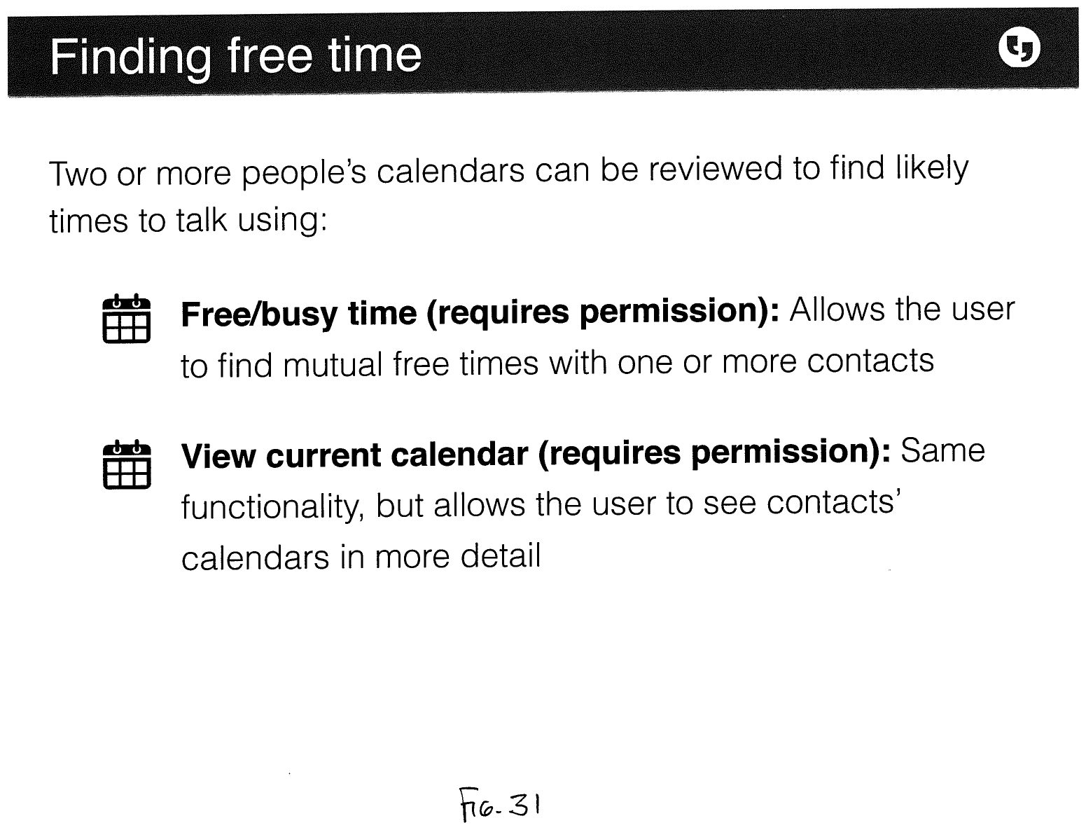

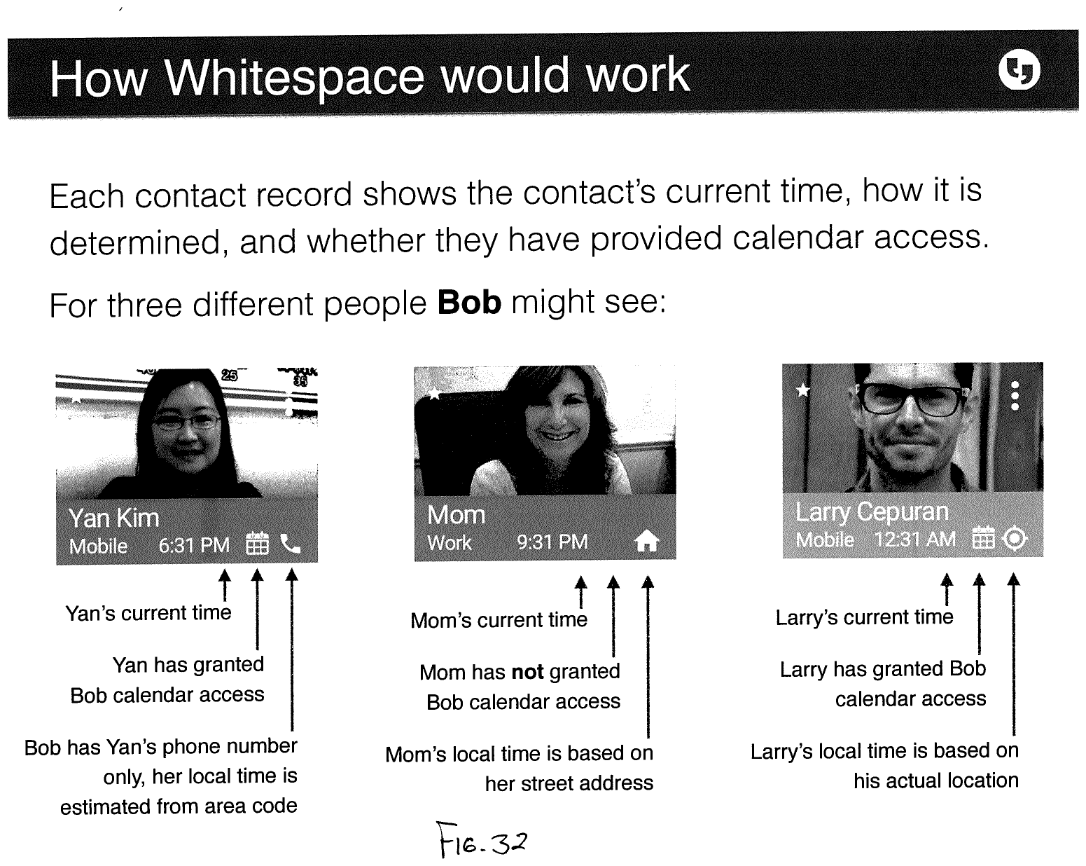

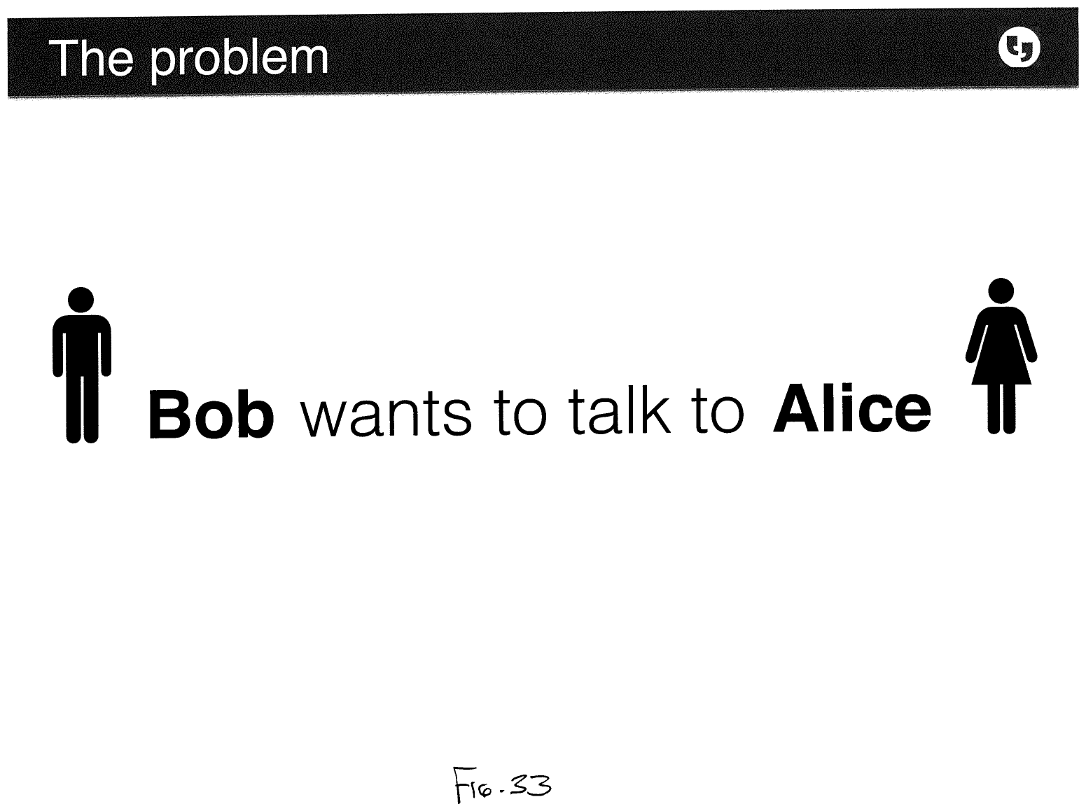

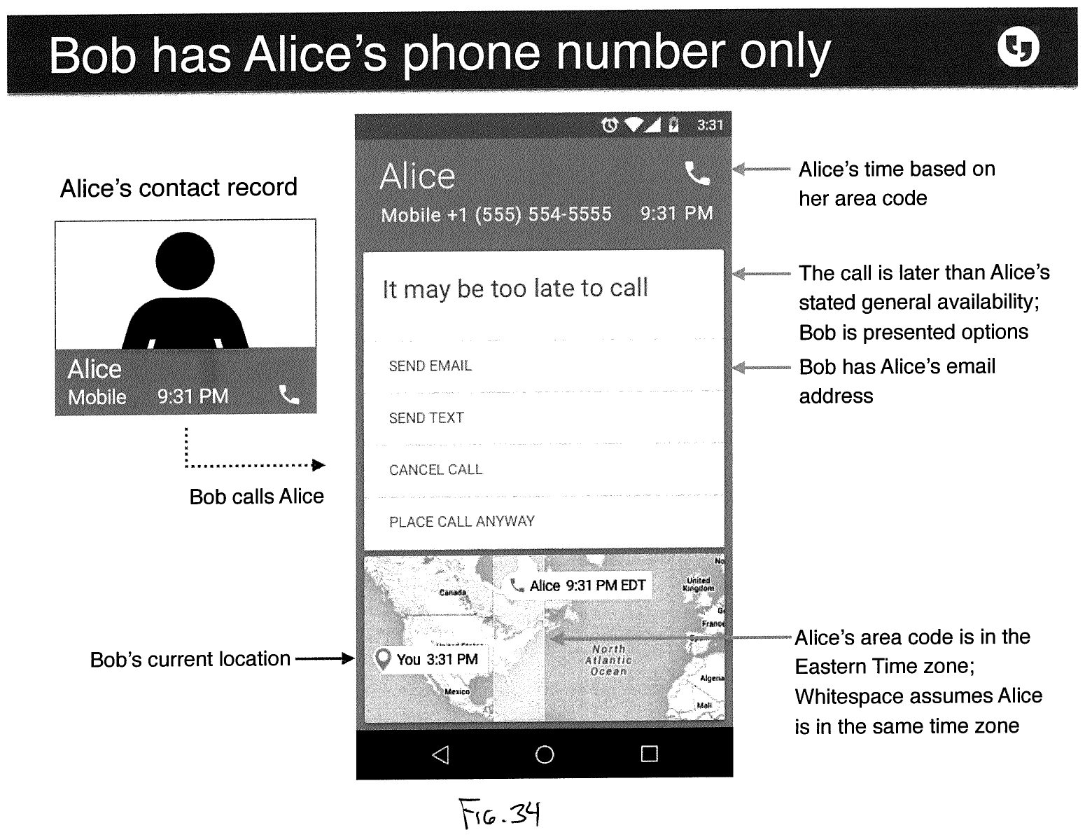

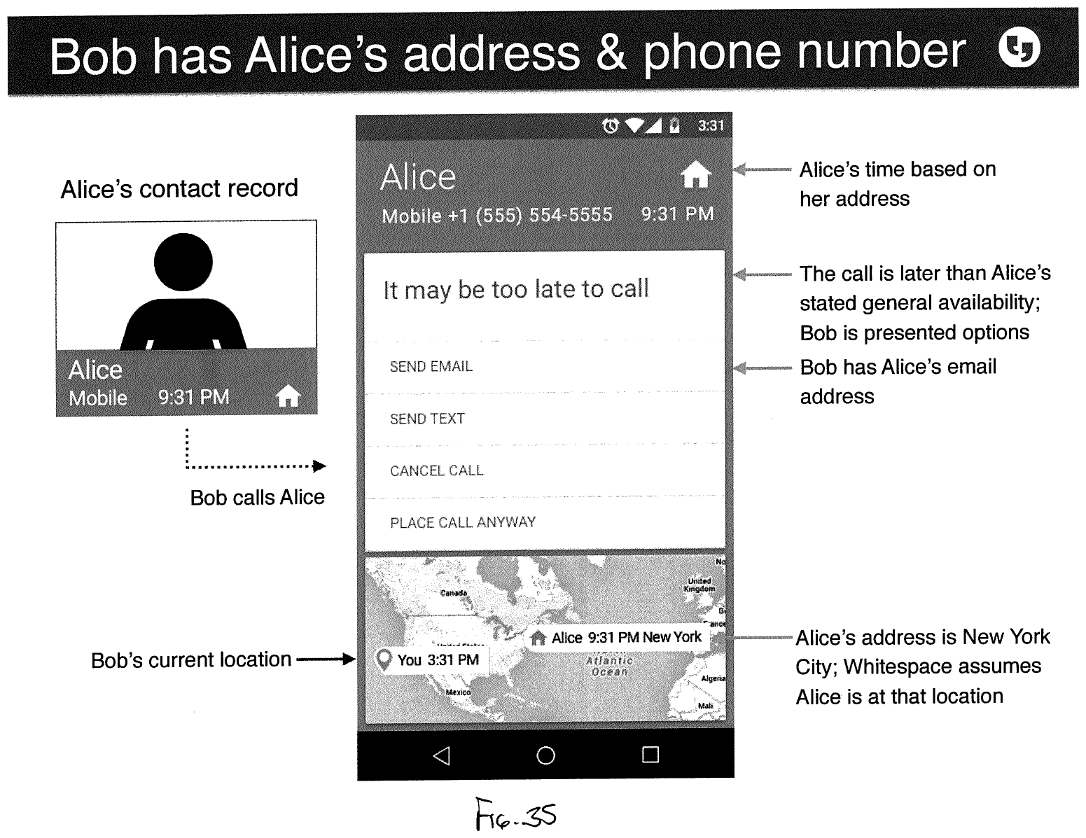

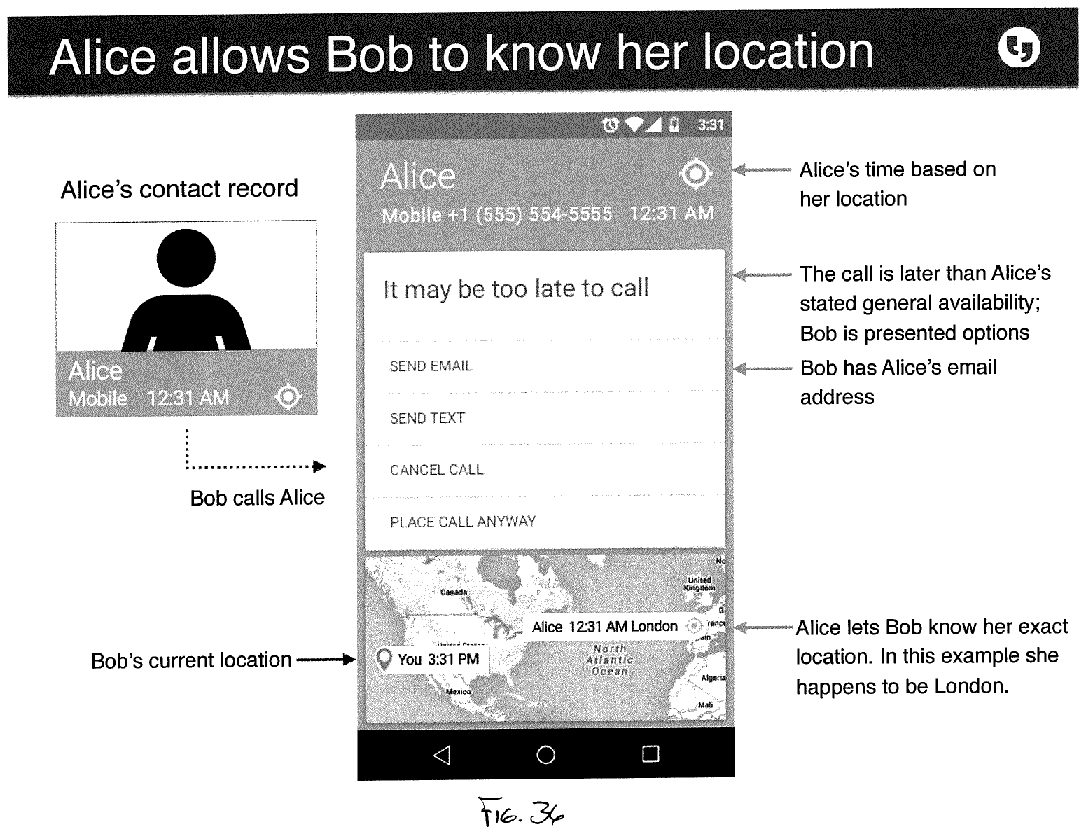

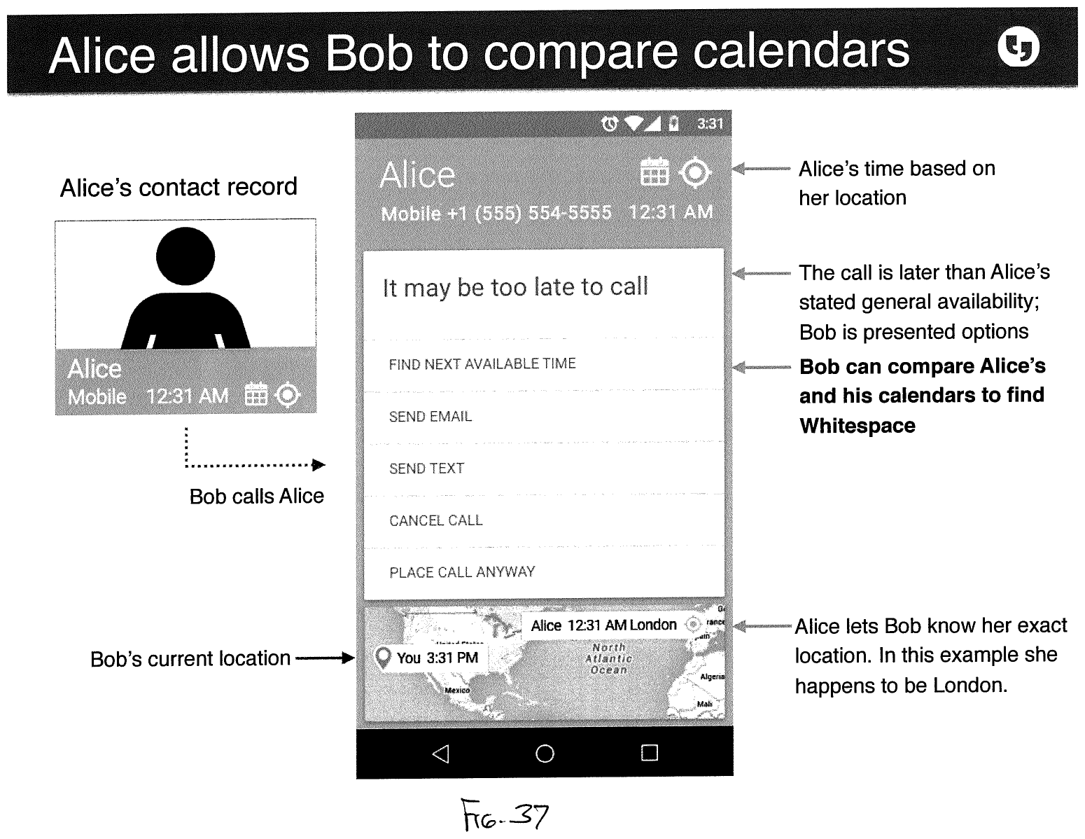

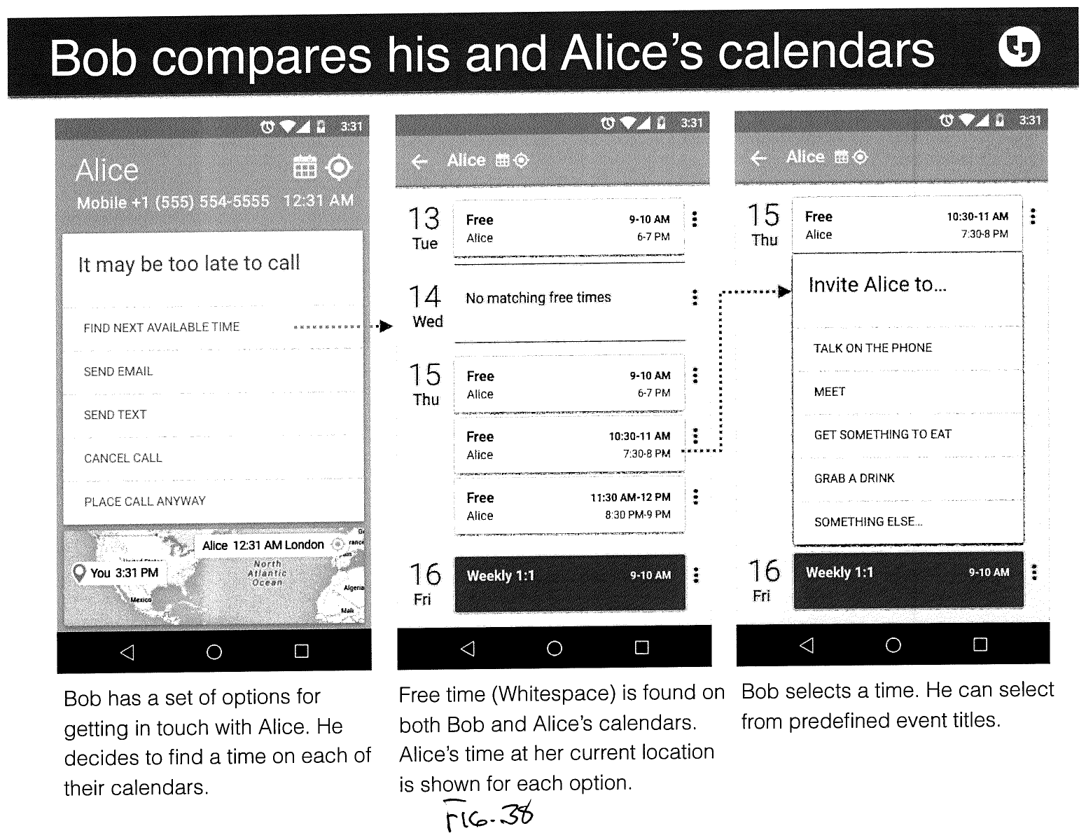

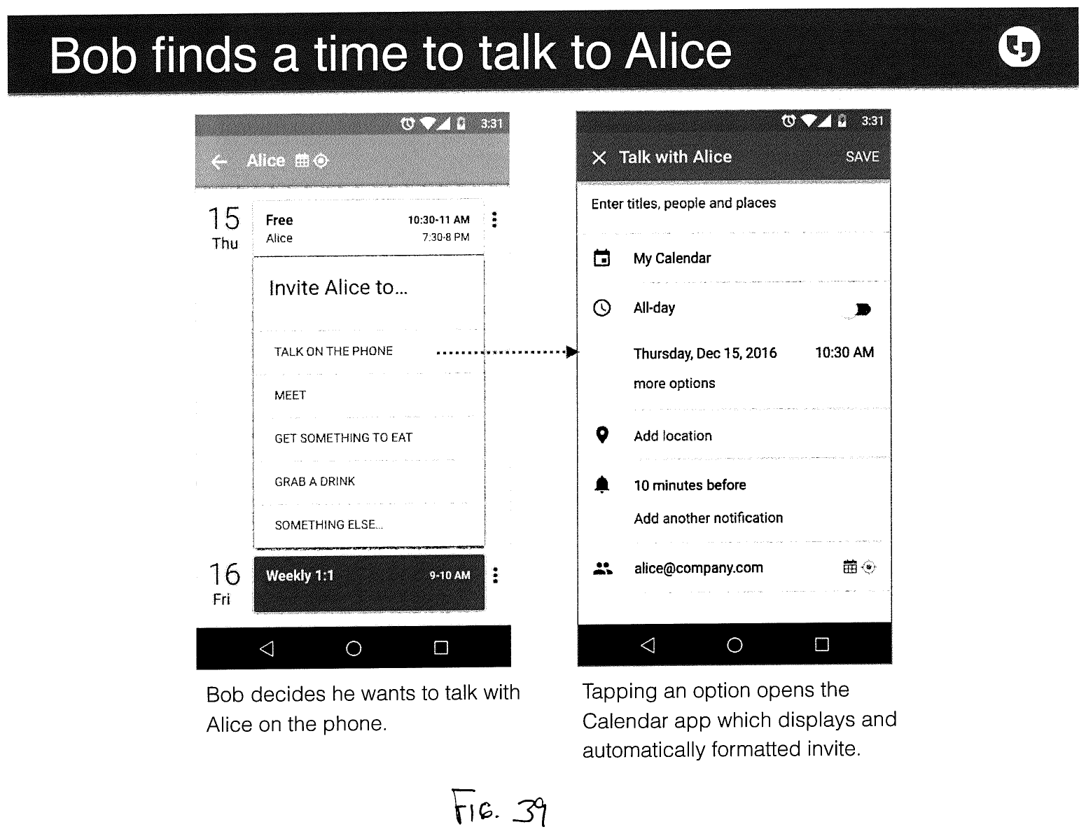

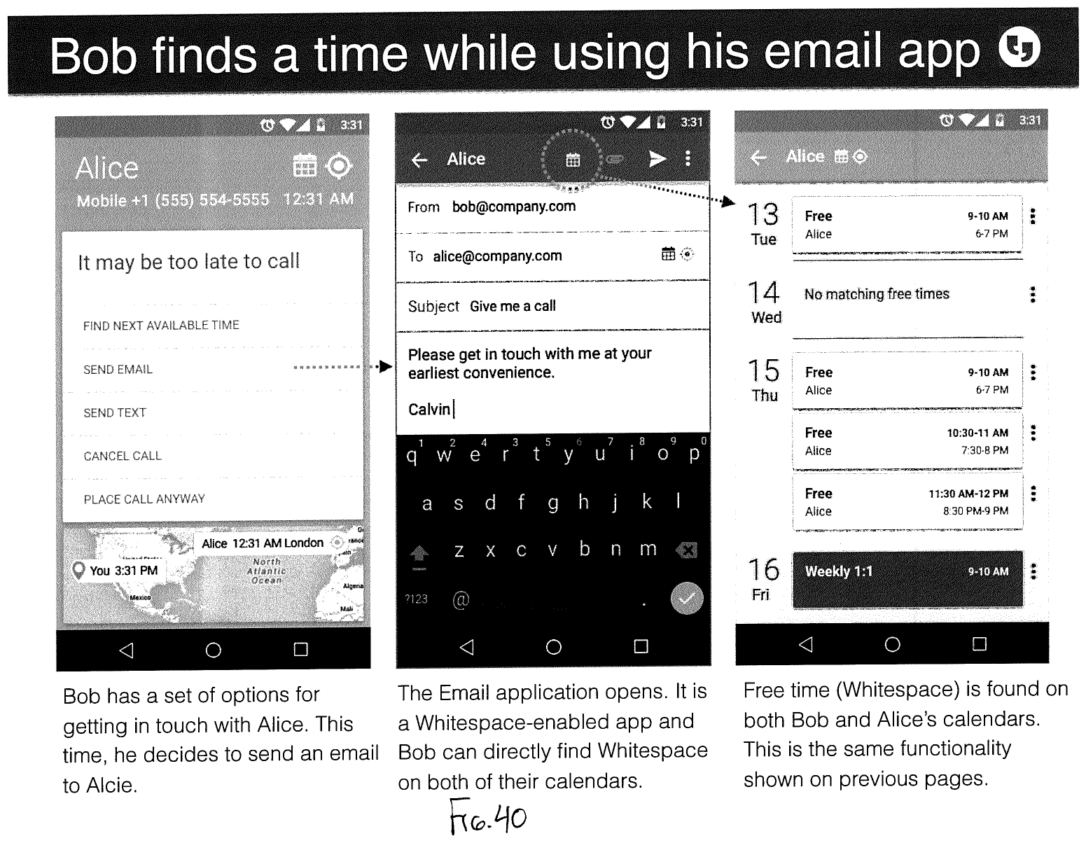

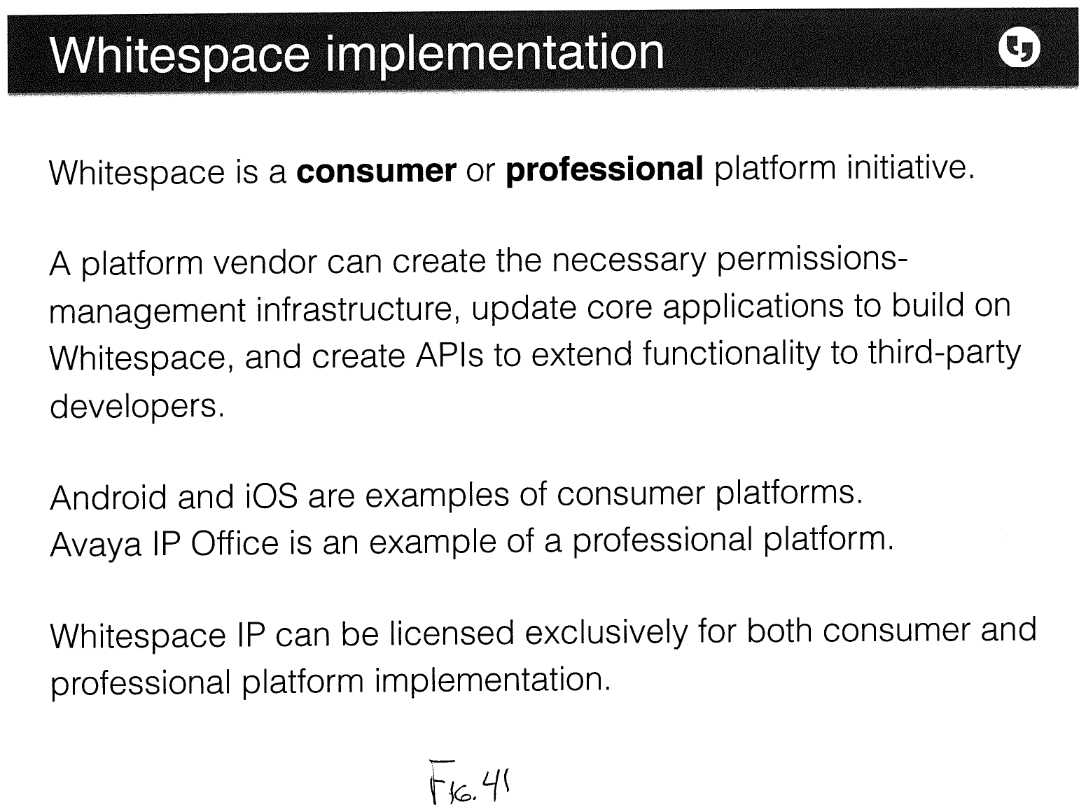

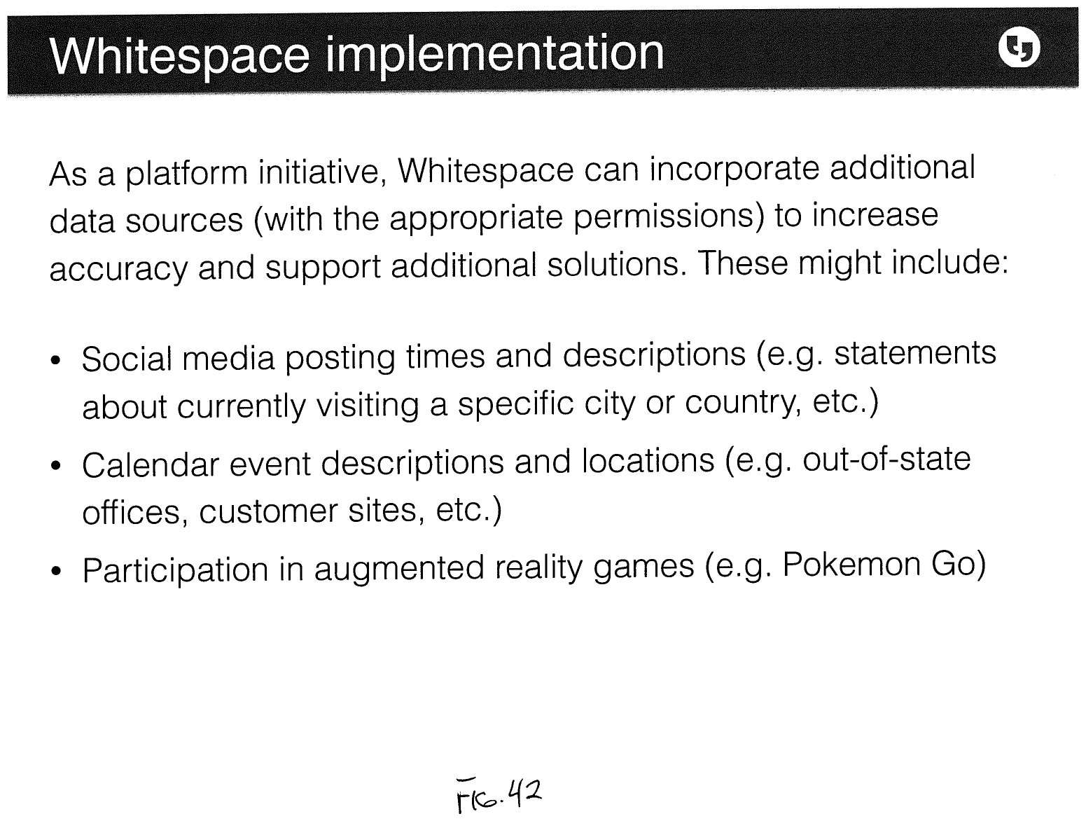

Embodiments described herein include applications configured to integrate users' contact, communication, location, and calendar services to reduce the complexity of scheduling phone calls and meetings. More particularly, further examples follow including the application described herein. FIGS. 19-42 include example flows of Whitespace operations, under an embodiment.

For example, two people may send roughly eight emails to schedule a single meeting. Whitespace is an application or component configured to integrate users' contact, communication, location, and calendar services to reduce the complexity of scheduling phone calls and meetings. Business users currently receive, on average, 120-140 emails per day, with only 45-53 needing a reply. Scheduling a single meeting, therefore, can account for nearly 10% of a user's daily required email traffic.

Whitespace is ideal for users with complex scheduling needs, especially those involving multi-office work arrangements and frequent travel. Whitespace is configured to determine whether an immediate, real-time interaction is likely to be successful and, if not, quickly identify mutual free times—whitespace, if you will—on attendees' calendars suitable for a meeting or call sometime in the future. Whitespace addresses the high-stress state in which a user needs to contact someone NOW—either because there's no time to wait for a text or email response or because the subject matter is too complex or emotional for anything other than a real-time discussion. The user wants to know if now is a good time to call (is it too early or too late?) and, if not, when's the next appropriate time to try. Whitespace also addresses day-to-day scheduling needs, including those that arise while writing emails and texts.

Whitespace components include location and availability. Whitespace integrates commonly-known information about someone's location to determine whether now is a good time to talk. An embodiment is configured to use location based on area code, which provides the least accuracy, with no privacy issues. Most real-time communication is still conducted on the phone. Placing a call to another phone is still fundamentally much easier than using services such as Skype. To place a call a user needs to know the other person's phone number. Even though a person's area code conveys no information about actual location, it does serve as a first-order, but still error-prone, means of determining someone's likely location.

An embodiment is configured to use location based on address provides greater accuracy with no privacy issues. Someone's physical address increases the accuracy of determining their likely location. Just as with an area code, there's no guarantee that someone will be at their home or work address. Whitespace functionality of an embodiment assumes someone will be at their stated address more often than not, but is not so limited.

An embodiment is configured to use location-based geolocation services to provide complete accuracy, but with many potential privacy issues. This is the most accurate means of determining someone's location. However, it requires the user to obtain permission from other people in order to know their real-time locations. With use of Whitespace, providing geolocation information can have two degrees of accuracy. Someone can provide permission to know their time zone but not their specific location (e.g. Eastern Time, but not whether they are in New York, Miami, or somewhere else); or their actual location (e.g. New York). By correlating the user's current time, and the likely or actual time of the person they wish to contact, Whitespace can immediately help the user decide whether to continue a call.

If now is not a good time to call, Whitespace is configured to provide additional services based on availability. Whitespace requires the user to know the calendar availability of the person they wish to call. As with geolocation, this requires permission and has two levels of accuracy. Someone can provide permission to know their free/busy state (the true representation of “whitespace”) or the details of their schedule. So, if now is not a good time to call, Whitespace presents the user with the means of setting up the next possible meeting time.

Whitespace is about integration between common applications and services, especially contacts, phone, and calendar. A user's contacts application can include real-time status about people based on known and permitted information. A contact record would include that person's local time based on what the user knows or is permitted to know about them (e.g., area code, address, geolocation, etc.).

When operating with the phone application, the call status screen can provide options if it turns out that now might not be a good time to call. Options can include but are not limited to the following: find the next available time (opens Calendar which presents the whitespace on both persons' schedules); email, text, or contact the person some other way based on information in their contact record; cancel the call; place the call anyway.

Whitespace is configured where proposing meetings on a Whitespace-enabled platform is similar to conventional calendar invite features. The difference is that the invite feature can be accessed from any other Whitespace-enabled app directly. In the case of making a phone call, if the user decides to schedule a meeting instead (see phone application above), they are presented with an automatically-configured meeting invite that includes the person they are calling and a list of available times. The user does not have to leave the phone app and manually create an invitation.

Text, email, and other communication applications can also be integrated into a Whitespace experience. For example, when making a phone call, if the user decides to send an email instead of placing the call, they are presented with an email form automatically-addressed to the person that had wanted to call. Conversely, if during the writing of an email the user wanted to propose a meeting time, Whitespace could automatically configure a meeting invite including everyone in the email address line.

Embodiments herein include an application running on a processor of a client device configured for telephone communications. The application configures the client device to, in response to receiving an input to initiate a telephone call to a selected contact, receive data of the selected contact. The application configures the client device to determine a current time of the selected contact based on a location corresponding to the selected contact. The application configures the client device to determine from the data of the selected contact and the current time an appropriate time to call the selected contact. The application configures the client device to generate a display at the client device including a message comprising message data and a plurality of contact options. The message data is representative of the appropriate time to call the selected contact. The plurality of contact options includes messaging options and calling options. The application configures the client device to integrate data of the message into at least one of a speed dial interface, call preview interface, contact data, shared calendar interface, and a scheduling application.

Embodiments herein include a method comprising: an application running on a processor of a client device configured for telephone communications, wherein the application configures the client device to, in response to receiving an input to initiate a telephone call to a selected contact, receive data of the selected contact; determine a current time of the selected contact based on a location corresponding to the selected contact; determine from the data of the selected contact and the current time an appropriate time to call the selected contact; and generate a display at the client device including a message comprising message data and a plurality of contact options, wherein the message data is representative of the appropriate time to call the selected contact, wherein the plurality of contact options include messaging options and calling options. The application configures the client device to integrate data of the message into at least one of a speed dial interface, call preview interface, contact data, shared calendar interface, and a scheduling application.

The data of the selected contact includes data included in a database accessed by the client device.

The data of the selected contact includes data received at the client device from a remote client device, wherein the remote client device includes a client device of the selected contact.

The data of the selected contact includes data received at the client device from a corresponding application of the remote client device, wherein the corresponding application corresponds to the application.

The corresponding application is configured to include a user interface comprising a plurality of controls, wherein a first control of the plurality of controls is configured to control provision of the data to the client device.

A second control of the plurality of controls is configured to control provision of the appropriate time to the client device.

A third control of the plurality of controls is configured to control input of an earliest time of the appropriate time.

A fourth control of the plurality of controls is configured to control input of a latest time of the appropriate time.

The data of the selected contact includes data included in a database accessed by the client device, and data received at the client device from a remote client device, wherein the remote client device includes a client device of the selected contact.

The current time includes an actual time based on a location that is a current actual location of the selected contact.

The current time includes a time based on contact data of the selected contact.

The current time includes one of an actual time based on a location that is a current actual location of the selected contact, and a time based on contact data of the selected contact.

The current time includes the actual time based on the current actual location of the selected contact when the data of the selected contact includes data received at the client device from the remote client device of the selected contact.

The current time includes the time based on the contact data of the selected contact in the absence of the data received at the client device from the remote client device of the selected contact.

The plurality of contact options include at least one of an option to proceed with the initiated call, an option to cancel the initiated call, an option to text message the selected contact in lieu of placing the initiated call, an option to electronic mail message the selected contact in lieu of placing the initiated call, and an option to generate a calendar event including the selected contact in lieu of placing the initiated call.

The messaging options include an option to text message the selected contact in lieu of placing the initiated call.

The method comprises, in response to selection of the option to text message, generating a text message template pre-addressed to the selected contact.

The messaging options include an option to electronic mail message the selected contact in lieu of placing the initiated call.

The method comprises, in response to selection of the option to electronic mail message, generating an electronic mail message template pre-addressed to the selected contact.

The messaging options include an option to generate a calendar event including the selected contact in lieu of placing the initiated call.

The method comprises, in response to selection of the option to generate a calendar event, generating a calendar event template using data of the selected.

The calling options include an option to cancel the initiated call.

The calling options include an option to proceed with the initiated call.

Embodiments herein include a system comprising a client device including a first processor and configured for telephone communications. The first processor is running an application. The system includes a remote client device including a second processor and configured for telephone communications. The second processor is running the application. The application configures the client device and the remote client device to, in response to receiving an input at the client device to initiate a telephone call to a selected contact at the remote client device, receive data of the selected contact. The application configures the client device and the remote client device to determine a current time of the selected contact based on a location corresponding to the selected contact. The application configures the client device and the remote client device to determine from the data of the selected contact and the current time an appropriate time to call the selected contact. The application configures the client device and the remote client device to generate a display at the client device including a message comprising message data and a plurality of contact options. The message data is representative of the appropriate time to call the selected contact. The plurality of contact options includes messaging options and calling options. The application configures the client device to integrate data of the message into at least one of a speed dial interface, call preview interface, contact data, shared calendar interface, and a scheduling application.

Embodiments herein include a system comprising: a client device including a first processor and configured for telephone communications, wherein the first processor is running an application; a remote client device including a second processor and configured for telephone communications, wherein the second processor is running the application; wherein the application configures the client device and the remote client device to, in response to receiving an input at the client device to initiate a telephone call to a selected contact at the remote client device, receive data of the selected contact; determine a current time of the selected contact based on a location corresponding to the selected contact; determine from the data of the selected contact and the current time an appropriate time to call the selected contact; and generate a display at the client device including a message comprising message data and a plurality of contact options, wherein the message data is representative of the appropriate time to call the selected contact, wherein the plurality of contact options include messaging options and calling options. The application configures the client device to integrate data of the message into at least one of a speed dial interface, call preview interface, contact data, shared calendar interface, and a scheduling application.

The data of the selected contact includes data included in a database accessed by the client device.

The data of the selected contact includes data received at the client device from the remote client device, wherein the remote client device includes a client device of the selected contact.

The data of the selected contact includes data received at the client device from a corresponding application of the remote client device, wherein the corresponding application corresponds to the application.

The corresponding application is configured to include a user interface comprising a plurality of controls, wherein a first control of the plurality of controls is configured to control provision of the data to the client device.

A second control of the plurality of controls is configured to control provision of the appropriate time to the client device.

A third control of the plurality of controls is configured to control input of an earliest time of the appropriate time.

A fourth control of the plurality of controls is configured to control input of a latest time of the appropriate time.

The data of the selected contact includes data included in a database accessed by the client device, and data received at the client device from the remote client device, wherein the remote client device includes a client device of the selected contact.

The current time includes an actual time based on a location that is a current actual location of the selected contact.

The current time includes a time based on contact data of the selected contact.

The current time includes one of an actual time based on a location that is a current actual location of the selected contact, and a time based on contact data of the selected contact.

The current time includes the actual time based on the current actual location of the selected contact when the data of the selected contact includes data received at the client device from the remote client device of the selected contact.

The current time includes the time based on the contact data of the selected contact in the absence of the data received at the client device from the remote client device of the selected contact.

The plurality of contact options include at least one of an option to proceed with the initiated call, an option to cancel the initiated call, an option to text message the selected contact in lieu of placing the initiated call, an option to electronic mail message the selected contact in lieu of placing the initiated call, and an option to generate a calendar event including the selected contact in lieu of placing the initiated call.

The messaging options include an option to text message the selected contact in lieu of placing the initiated call.

The application configures the client device and the remote client device to, in response to selection of the option to text message, generate a text message template pre-addressed to the selected contact.

The messaging options include an option to electronic mail message the selected contact in lieu of placing the initiated call.

The application configures the client device and the remote client device to, in response to selection of the option to electronic mail message, generate an electronic mail message template pre-addressed to the selected contact.

The messaging options include an option to generate a calendar event including the selected contact in lieu of placing the initiated call.

The application configures the client device and the remote client device to, in response to selection of the option to generate a calendar event, generate a calendar event template using data of the selected.

The calling options include an option to cancel the initiated call.

The calling options include an option to proceed with the initiated call.

The components described herein can be located together or in separate locations. Communication paths couple the components and include any medium for communicating or transferring files among the components. The communication paths include wireless connections, wired connections, and hybrid wireless/wired connections. The communication paths also include couplings or connections to networks including local area networks (LANs), metropolitan area networks (MANs), wide area networks (WANs), proprietary networks, interoffice or backend networks, and the Internet. Furthermore, the communication paths include removable fixed mediums like floppy disks, hard disk drives, and CD-ROM disks, as well as flash RAM, Universal Serial Bus (USB) connections, RS-232 connections, telephone lines, buses, and electronic mail messages.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the systems and methods include: microcontrollers with memory (such as electronically erasable programmable read only memory (EEPROM)), embedded microprocessors, firmware, software, etc. Furthermore, aspects of the systems and methods may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

It should be noted that any system, method, and/or other components disclosed herein may be described using computer aided design tools and expressed (or represented), as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, HTTPs, FTP, SMTP, WAP, etc.). When received within a computer system via one or more computer-readable media, such data and/or instruction-based expressions of the above described components may be processed by a processing entity (e.g., one or more processors) within the computer system in conjunction with execution of one or more other computer programs.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word: any of the items in the list, all of the items in the list and any combination of the items in the list.

The above description of embodiments of the systems and methods is not intended to be exhaustive or to limit the systems and methods to the precise forms disclosed. While specific embodiments of, and examples for, the systems and methods are described herein for illustrative purposes, various equivalent modifications are possible within the scope of the systems and methods, as those skilled in the relevant art will recognize. The teachings of the systems and methods provided herein can be applied to other systems and methods, not only for the systems and methods described above.

The elements and acts of the various embodiments described above can be combined to provide further embodiments. These and other changes can be made to the systems and methods in light of the above detailed description.

What is claimed is:

1. A method comprising:
an application running on a processor of a client device configured for telephone communications, wherein the application configures the client device to,
in response to receiving an input to initiate a telephone call to a selected contact, receive data of the selected contact;
determine a current time of the selected contact based on a location corresponding to the selected contact;
determine from the data of the selected contact and the current time an appropriate time to call the selected contact;
generate a display at the client device including a message comprising message data and a plurality of contact options, wherein the message data is representative of the appropriate time to call the selected contact, wherein the plurality of contact options include messaging options and calling options; and
integrate data of the message into at least one of a speed dial interface, call preview interface, contact data, shared calendar interface, and a scheduling application.

2. The method of claim 1, wherein the data of the selected contact includes data included in a database accessed by the client device.

3. The method of claim 1, wherein the data of the selected contact includes data received at the client device from a remote client device, wherein the remote client device includes a client device of the selected contact.

4. The method of claim 3, wherein the data of the selected contact includes data received at the client device from a corresponding application of the remote client device, wherein the corresponding application corresponds to the application.

5. The method of claim 4, wherein the corresponding application is configured to include a user interface comprising a plurality of controls, wherein a first control of the plurality of controls is configured to control provision of the data to the client device.

6. The method of claim 5, wherein a second control of the plurality of controls is configured to control provision of the appropriate time to the client device.

7. The method of claim 6, wherein a third control of the plurality of controls is configured to control input of an earliest time of the appropriate time.

8. The method of claim 7, wherein a fourth control of the plurality of controls is configured to control input of a latest time of the appropriate time.

9. The method of claim 1, wherein the data of the selected contact includes data included in a database accessed by the client device, and data received at the client device from a remote client device, wherein the remote client device includes a client device of the selected contact.

10. The method of claim 1, wherein the current time includes an actual time based on a location that is a current actual location of the selected contact.

11. The method of claim 1, wherein the current time includes a time based on contact data of the selected contact.

12. The method of claim 1, wherein the current time includes one of an actual time based on a location that is a current actual location of the selected contact, and a time based on contact data of the selected contact.

13. The method of claim 12, wherein the current time includes the actual time based on the current actual location of the selected contact when the data of the selected contact includes data received at the client device from the remote client device of the selected contact.

14. The method of claim 12, wherein the current time includes the time based on the contact data of the selected contact in the absence of the data received at the client device from the remote client device of the selected contact.

15. The method of claim 1, wherein the plurality of contact options include at least one of an option to proceed with the initiated call, an option to cancel the initiated call, an option to text message the selected contact in lieu of placing the initiated call, an option to electronic mail message the selected contact in lieu of placing the initiated call, and an option to generate a calendar event including the selected contact in lieu of placing the initiated call.

16. The method of claim 1, wherein the messaging options include an option to text message the selected contact in lieu of placing the initiated call.

17. The method of claim 16, comprising, in response to selection of the option to text message, generating a text message template pre-addressed to the selected contact.

18. The method of claim 1, wherein the messaging options include an option to electronic mail message the selected contact in lieu of placing the initiated call.

19. The method of claim 18, comprising, in response to selection of the option to electronic mail message, generating an electronic mail message template pre-addressed to the selected contact.

20. The method of claim 1, wherein the messaging options include an option to generate a calendar event including the selected contact in lieu of placing the initiated call.

21. The method of claim 20, comprising, in response to selection of the option to generate a calendar event, generating a calendar event template using data of the selected.

22. The method of claim 1, wherein the calling options include an option to cancel the initiated call.

23. The method of claim 1, wherein the calling options include an option to proceed with the initiated call.

24. A system comprising:
a client device including a first processor and configured for telephone communications, wherein the first processor is running an application;
a remote client device including a second processor and configured for telephone communications, wherein the second processor is running the application;
wherein the application configures the client device and the remote client device to,
in response to receiving an input at the client device to initiate a telephone call to a selected contact at the remote client device, receive data of the selected contact;
determine a current time of the selected contact based on a location corresponding to the selected contact;
determine from the data of the selected contact and the current time an appropriate time to call the selected contact;
generate a display at the client device including a message comprising message data and a plurality of contact options, wherein the message data is representative of the appropriate time to call the selected contact, wherein the plurality of contact options include messaging options and calling options; and
integrate data of the message into at least one of a speed dial interface, call preview interface, contact data, shared calendar interface, and a scheduling application.

25. The system of claim 24, wherein the data of the selected contact includes data included in a database accessed by the client device.

26. The system of claim 24, wherein the data of the selected contact includes data received at the client device from the remote client device, wherein the remote client device includes a client device of the selected contact.

27. The system of claim 26, wherein the data of the selected contact includes data received at the client device from a corresponding application of the remote client device, wherein the corresponding application corresponds to the application.

28. The system of claim 27, wherein the corresponding application is configured to include a user interface comprising a plurality of controls, wherein a first control of the plurality of controls is configured to control provision of the data to the client device.

29. The system of claim 28, wherein a second control of the plurality of controls is configured to control provision of the appropriate time to the client device.

30. The system of claim 29, wherein a third control of the plurality of controls is configured to control input of an earliest time of the appropriate time.

31. The system of claim 30, wherein a fourth control of the plurality of controls is configured to control input of a latest time of the appropriate time.

32. The system of claim 24, wherein the data of the selected contact includes data included in a database accessed by the client device, and data received at the client device from the remote client device, wherein the remote client device includes a client device of the selected contact.

33. The system of claim 24, wherein the current time includes an actual time based on a location that is a current actual location of the selected contact.

34. The system of claim 24, wherein the current time includes a time based on contact data of the selected contact.

35. The system of claim 24, wherein the current time includes one of an actual time based on a location that is a current actual location of the selected contact, and a time based on contact data of the selected contact.

36. The system of claim 35, wherein the current time includes the actual time based on the current actual location of the selected contact when the data of the selected contact includes data received at the client device from the remote client device of the selected contact.

37. The system of claim 35, wherein the current time includes the time based on the contact data of the selected contact in the absence of the data received at the client device from the remote client device of the selected contact.

38. The system of claim 24, wherein the plurality of contact options include at least one of an option to proceed with the initiated call, an option to cancel the initiated call, an option to text message the selected contact in lieu of placing the initiated call, an option to electronic mail message the selected contact in lieu of placing the initiated call, and an option to generate a calendar event including the selected contact in lieu of placing the initiated call.

39. The system of claim 24, wherein the messaging options include an option to text message the selected contact in lieu of placing the initiated call.

40. The system of claim 39, comprising, in response to selection of the option to text message, generating a text message template pre-addressed to the selected contact.

41. The system of claim 24, wherein the messaging options include an option to electronic mail message the selected contact in lieu of placing the initiated call.

42. The system of claim 41, comprising, in response to selection of the option to electronic mail message, generating an electronic mail message template pre-addressed to the selected contact.

43. The system of claim 24, wherein the messaging options include an option to generate a calendar event including the selected contact in lieu of placing the initiated call.

44. The system of claim 43, comprising, in response to selection of the option to generate a calendar event, generating a calendar event template using data of the selected.

45. The system of claim 24, wherein the calling options include an option to cancel the initiated call.

46. The system of claim 24, wherein the calling options include an option to proceed with the initiated call.
